(19) United States
(12) Patent Application Publication
(10) Pub. No.: US 2023/0047663 A1
(43) Pub. Date: Feb. 16, 2023

(54) METASURFACES FOR HIGH EFFICIENCY WIRELESS POWER TRANSFER SYSTEMS

(71) Applicant: The Board of Trustees of the University of Illinois, Urbana, IL (US)

(72) Inventors: Hanwei Wang, Urbana, IL (US); Yang Zhao, Urbana, IL (US); Yun-Sheng Chen, Urbana, IL (US)

(21) Appl. No.: 17/871,567

(22) Filed: Jul. 22, 2022

Related U.S. Application Data
(60) Provisional application No. 63/226,015, filed on Jul. 27, 2021.

(51) Int. Cl. H02J 50/00; H02J 50/12; H02J 50/40; H04B 5/00

(52) U.S. Cl. CPC H02J 50/005; H02J 50/12; H02J 50/402; H04B 5/0037

(57) ABSTRACT

A metasurface for wireless power transfer includes an insulated support structure. A plurality of magnetically coupled resonators are insulated and supported by the insulated support structure. The plurality of coupled resonators are configured and arranged to couple within and shape a magnetic near field distribution from a transmitter into a target distribution toward a target receiver. The plurality of coupled resonators form a non-uniform impedance distribution pattern to provide the shape of the target distribution. The insulated support structure can be thin and flexible, allowing it to be worn by a person, for example to transfer power to an implanted device.

### PRIORITY CLAIM AND REFERENCE TO RELATED APPLICATION

The application claims priority under 35 U.S.C. § 119 and all applicable statutes and treaties from prior U.S. provisional application Ser. No. 63/226,015 which was filed Jul. 27, 2021.

### FIELD

Fields of the invention include wireless power transfer, wireless charging, metamaterials and metasurfaces. Example applications of the invention include charging of implanted medical devices, powering implanted sensors, and power transfer to other devices and systems that can benefit from remote (small distance separation in the magnetic near field) wireless power transfer, such as phones, laptops, pads, watches, earphones, capsule endoscopes, and insulin pumps.

### BACKGROUND

Wireless power transfer generally involves the use of magnetic fields and resonance to transmit power from a transmitter to a receiver. The general model for Wireless Power Transfer (WPT) involves the magnetic induction of strongly coupled resonators. This has provided the basis for wireless charging devices to charge phones, computers, and various sensors. See, e.g., Hui, S. Y. R.; Ho, W. W. C., “A New Generation of Universal Contactless Battery Charging Platform for Portable Consumer Electronic Equipment,” IEEE Trans. Power Electron. 2005, 20 (3), 620-627; Zhong, W. X.; Liu, X.; Hui, S. Y. R., “A Novel Single-Layer Winding Array and Receiver Coil Structure for Contactless Battery Charging Systems With Free-Positioning and Localized Charging Features,” IEEE Trans. Ind. Electron. 2011, 58 (9), 4136-4144; Xie, L.; Shi, Y.; Hou, Y. T.; Lou, A., “Wireless Power Transfer and Applications to Sensor Networks,” IEEE Wirel. Commun. 2013, 20 (4), 140-145; Madhja, A.; Nikoletseas, S.; Raptis, T. P. Distributed Wireless Power Transfer in Sensor Networks with Multiple Mobile Chargers. Comput. Netw. 2015, 80, 89-108; Agarwal, K.; Jegadeesan, R.; Guo, Y.-X.; Thakor, N. V., “Wireless Power Transfer Strategies for Implantable Bioelectronics,” IEEE Rev. Biomed. Eng. 2017, 10, 136-16.

Such power transfer devices suffer from low efficiency and high field leakage because of the fast divergence of magnetic fields in space. See, e.g., Hui et al., “A Critical Review of Recent Progress in Mid-Range Wireless Power Transfer,” IEEE Transactions on Power Electronics (Volume: 29, Issue: 9, Sep. 2014): Madhja, A.; Nikoletseas, S.; Raptis, T. P., “Distributed Wireless Power Transfer in Sensor Networks with Multiple Mobile Chargers,” Comput. Netw. 2015, 80, 89-108.

Increasing the number of transmitting (Tx) coils is one way to increase efficiency and better confine the magnetic field. Examples of this approach include Magnetic MIMO, MultiSpot, Hybrid Directional and Rotational WPT, and adaptive phased-array for WPT. Jadidian, J.; Katabi, D., “Magnetic MIMO: How to Charge Your Phone in Your Pocket,” Proceeding of the 20^{th} annual international conference on Mobile computing and networking 2014, 495-406; Shi, L.; Kabelac, Z.; Katabi, D.; Perreault, D., “Wireless Power Hotspot that Charges All of Your Devices,” Proceeding of the 21^{th} annual international conference on Mobile computing and networking 2015, 2-13; Wang, H.; Zhang, C.; Yang, Y.; Liang, R. H. W.; Hui, S. Y., “A Comparative Study on Overall Efficiency of 2-Dimensional Wireless Power Transfer Systems Using Rotational and Directional Methods,” IEEE Trans. Ind. Electron. 2021; Waters, B.; Brody, J.; Ranganathan, V.; Smith, J, “Power Delivery and Leakage Field Control Using an Adaptive Phased Array Wireless Power System,” IEEE Trans. Power Electron. 2015, 30(11), 6298-6309. A drawback is that each Tx coil requires an independent power source that has controllable output voltages and phase-shift. Despite the power-hungry demands of such approaches, a typical efficiency increase is only 10% compared to a comparable single Tx coil system.

Passive resonant coils have also been used. When a nonlinear resonant coil that has a variable resonance frequency depending on the coupling condition is employed, the operational bandwidth is significantly increased, making the WPT system more robust. Assawaworrarit, S.; Yu, X.; Fan, S., “Robust Wireless Power Transfer Using a Nonlinear Parity-Time-Symmetric Circuit,” Nature 2017, 546 (7658), 387-390. While this provides increased efficiency, the multiple resonators need to be placed in parallel between the Tx and receiving (Rx) coils, which greatly undermines the advantage and convenience of WPT.

Metamaterials use an array of coupled resonators, being often phase-tunable, to reshape the wavefront of radiative waves. Poddubny, A.; Iorsh, I.; Belov, P.; Kivshar, Y. “Hyperbolic Metamaterials,” Nat. Photonics 2013, 7(12), 948-957; Zhu, J.; Christensen, J.; Jung, J.; Martin-Moreno, L.; Yin, X.; Fok, L.; Zhang, X.; Garcia-Vidal, F. J. A “Holey-Structured Metamaterial for Acoustic Deep-Subwavelength Imaging,” Nat. Phys. 2011, 7 (1), 52-55; Yu, N.; Genevet, P.; Kats, M. A.; Aieta, F.; Tetienne, J.-P.; Capasso, F.; Gaburro, Z., “Light Propagation with Phase Discontinuities: Generalized Laws of Reflection and Refraction,” Science 2011, 334 (6054), 333-337.

Metasurfaces, the two-dimensional (2D) counterpart of metamaterials, demonstrate strong capabilities in redirecting and focusing radiative waves. Analogous to radiative metasurfaces, non-radiative magnetic metasurfaces have been proposed to enhance the magnetic field intensity for magnetic resonance imaging (MRI). lobozhanyuk, A. P.; Poddubny, A. N.; Raaijmakers, A. J. E.; Berg, C. A. T. van den; Kozachenko, A. V.; Dubrovina, I. A.; Melchakova, I. V.; Kivshar, Y. S.; Belov, P. A., “Enhancement of Magnetic Resonance Imaging with Metasurfaces,” Adv. Mater. 2016, 28 (9); Duan, G.; Zhao, X.; Anderson, S. W.; Zhang, X., “Boosting Magnetic Resonance Imaging Signal-to-Noise Ratio Using Magnetic Metamaterials,” Commun. Phys. 2019, 2 (1), 1-8; Wang, H.; Huang, H.-K.; Chen, Y.-S.; Zhao, Y., “On-Demand Field Shaping for Enhanced Magnetic Resonance Imaging Using an Ultrathin Reconfigurable Metasurface,” View, 2021, 20200099. This latter publication concerns a metasurface that operates at a high frequency (128 MHz) for 3T MRI.

A similar approach has been used for WPT. Ranaweera, A. L. a. K.; Pham, T. S.; Bui, H. N.; Ngo, V.; Lee, J.-W, “An Active Metasurface for Field-Localizing Wireless Power Transfer Using Dynamically Reconfigurable Cavities,” Sci. Rep. 2019, 9 (1), 11735. The magnetic metasurfaces consist of numeral passive inductive resonators that couple to the magnetic field and generate alternating currents. The currents can create an additional magnetic field and enhance the original field. However, the unit cell of the metasurface only possesses on- and off-states to control the enhancement area. As there are only two states, it cannot accurately shape the field distribution in the desired manner, which limits the enhancement of WPT efficiency. Even with 576 resonators reported in the paper, the enhancement of the efficiency cannot exceed 6.46 fold. Moreover, this design cannot work for more complicated purposes other than enhancing the WPT efficiency, for example, tuning the power ratio between multiple users, compensating non-uniform coupling, and omnidirectional field shaping (i.e., for non-parallel receivers).

In Agrawal, D. R.; Tanabe, Y.; Weng, D.; Ma, A.; Hsu, S.; Liao, S. Y.; Zhen, Z.; Zhu, Z. Y.; Sun, C.; Dong, Z.; Yang, F., “Conformal Phased Surfaces for Wireless Powering of Bioelectronic Microdevices,” Nat. Biomed. Eng. 2017, 1(3), 1-9, a device consists of multiple co-centered coils, named as conformal phased surface, is proposed to collect wireless power and delivery to its central location. The device is capable of forming surface power flow and concentrating magnetic power. However, its energy can only be focused on a fixed central point.

### SUMMARY OF THE INVENTION

A preferred metasurface for wireless power transfer includes an insulated support structure. A plurality of magnetically coupled resonators are insulated and supported by the insulated support structure. The plurality of coupled resonators are configured and arranged to couple within and shape a magnetic near field distribution from a transmitter into a target distribution toward a target receiver. The plurality of coupled resonators form a non-uniform impedance distribution pattern to provide the shape of the target distribution.

A method for setting a non-uniform impedance distribution pattern of a metasurface that includes an insulated support structure and a plurality of magnetically coupled resonators insulated and supported by the insulated support structure is provided. The method sets a position and size of a receiver coil, determines a Gaussian beam fitting the position and size, and sets the impedance distribution according to

$$Im ( {Z}_{n} ) = {ω}_{0} \hat{L} - \frac{1}{{ω}_{0} {C}_{n}} = \frac{{ω}_{0} {\sum }_{k = 1}^{m} {M}_{k n} {a}_{k}^{′}}{{a}_{n}^{′}} ,$$

where Zₙ is the impedance of the resonator, ω₀ is the operational frequency, \hat{L} is the self-inductance of the resonator, Cₙ is the compensation capacitancompensationce of the n^{th} resonator, Mₖ, is the mutual inductance between the k^{th} and n^{th} resonators, aₖ′ is the targeting current of the k^{th} resonator.

A method for fabricating a metasurface that includes an insulated support structure and a plurality of magnetically coupled resonators insulated and supported by the insulated support structure forms resonator pattern metal traces on a substrate with a sacrificial layer and protective layer under the traces. A layer of flexible insulator is attached to the metal traces. The sacrificial layer is removed to release the metal traces attached to the layer of flexible material with the protective layer preventing oxidation. The removing of the sacrificial layer preferably includes soaking the substrate in solution to float the patterns with weak attachment to the substrate and subsequently conducting the attaching via pouring and curing the flexible insulator onto the patterns with weak attachment to the substrate to complete transfer to the flexible insulator.

### BRIEF DESCRIPTION OF THE DRAWINGS

FIGS. 1A-1C are schematic diagrams of a preferred wearable metasurface;

FIGS. 1D and 1E are schematic diagrams that illustrate the metasurface of FIG. 1A in system that includes a power transmitter and a receiver;

FIGS. 2A-2F illustrate tuning the impedance of the metasurfaces that shape the targeting current distribution;

FIG. 3 is a block diagram of a preferred method for a controller that can be used to design preferred metasurfaces and systems of the invention;

FIGS. 4A and 4B are data that compare magnetic power density without and with and without a metasurface of the invention;

FIGS. 5A-5C respectively show the calculated efficiency as a function of the distance between the Rx coil and the metasurface, resulting current distribution, and cross-correlation between the targeting current distribution and the resulting current distribution with different Rx coil-metasurface distance;

FIGS. 6A and 6B respectively show the influence of FWHM of the targeting current distribution on the working distance and operational bandwidth;

FIGS. 7A-7D illustrate arrangements and target current distributions with uniformly coupled devices (FIGS. 7A and 7C) and non-uniformly coupled devices (FIGS. 7B and 7D);

FIGS. 8A-F show a lack of negative performance influence of geometric distortion of a preferred metasurface;

FIG. 9A shows a planar metasurface, and FIGS. 9B and 9C-9H respectively show an omnidirectional metasurface and impedance distributions to achieve uniform power densities with receivers of different orientations;

FIG. 10 shows an impedance curve with different number of resonator rings;

FIGS. 11A-111D illustrate the properties of an example capacitor-free metasurface;

FIGS. 12A-12C concern efficiency vs frequency of the capacitor-free metasurface;

FIGS. 13A-13D illustrate the surface power flow of the metasurface;

FIG. 14 illustrates an arrangement with interlaced resonators in different layers;

FIGS. 15A &15B illustrate an impedance distribution to shape single Gaussian beam with different center locations;

FIGS. 16A and 16B show an impedance distribution for two Gaussian beams with different intensities;

FIGS. 17A and 17B illustrate a test device used in experiments to construct different metasurfaces and WPT systems of the invention;

FIGS. 18A-18E illustrate patterns constructed in experiments with the FIGS. 17A and 17B test device;

FIG. 19 includes plots of experimental and theoretical efficiencies for power transfer with and without a metasurface of the invention;

FIGS. 20A-20D show with impedance distributions that can change the power density distribution at the position of two receivers in a preferred WPT system;

FIGS. 21A-21F are data that account for the skin effect in a WPT system of the invention to power a receiver that is an implant in a person or animal; and

FIGS. 22A-22E illustrate a preferred fabrication process for making a thin and flexible metasurface of the invention.

### DETAILED DESCRIPTION OF THE PREFERRED EMBODIMENTS

A preferred embodiment is a metasurface for wireless power transfer. The metasurface includes an insulated support structure. A plurality of coupled resonators is insulated and supported by the insulated support structure. The plurality of coupled resonators is configured and arranged to shape a magnetic near field distribution from a transmitter toward a target receiver. The plurality of coupled resonators includes a non-uniform impedance distribution pattern to provide the shape of the magnetic near field distribution.

The insulated support structure can be a wearable patch. The insulated support structure is preferably flexible and configured to be worn by a person. The insulated support structure is preferably sized in the range of 5 cm to 20 cm in diameter, which can refer to the longest line passing through the center of the shape of the support structure that can be circular, triangular, rectangular, square, etc. Generally, the shape of the support structure can be arbitrary so long as it accommodates the pattern of resonators used in the metasurface.

The non-uniform impedance distribution pattern can be predetermined according to a predetermined position and distance relationship between a receiver and a transmitter. The predetermined position and distance relationship can be defined from one of the following: a body surface position and the position of an implant; a device surface position and the position of a receiver for a power source of the device; the orientation of a receiver for the power source of a device; multiple devices' positions and the relative positions of the receivers for the devices.

The non-uniform impedance distribution pattern can be adjustable via adjustable impedance of individual resonators and coupling between resonators. The non-uniform impedance distribution pattern can be set by an external controller that adjusts the impedance of individual resonators according to information about the position between a transmitter and receiver. The external controller can adjust the impedance of individual resonators according to information about the position between a transmitter and multiple receivers to provide a selectable amount of power to each of the multiple receivers.

The resonators can include adjustable compensation capacitors. The resonators can also be designed without compensation capacitors to have a predetermined LC characteristic suited for a particular application in which the relationship between the metasurface, a receiver and a power transmitter is known.

The non-uniform impedance distribution pattern can be set according to

$$Im ( {Z}_{n} ) = {ω}_{0} \hat{L} - \frac{1}{{ω}_{0} {C}_{n}} = \frac{{ω}_{0} {\sum }_{k = 1}^{m} {M}_{k n} {a}_{k}^{′}}{{a}_{n}^{′}} ,$$

where Zₙ is the impedance of the resonator, ω₀ is the operational frequency, \hat{L} is the self-inductance of the resonator, Cₙ is the compenstation capacitance of the n^{th} resonator, Mₖₙ is the mutual inductance between the k^{th} and n^{th} resonators, aₖ′ is the targeting current of the k^{th} resonator.

In a preferred embodiment, the resonators are three-dimensional resonators configured such that the field can be shaped in a preferred direction.

A preferred method for targeting a receiver for wireless power transfer includes placing a metasurface between a wireless power transmitter and a wireless power receiver. Power is transmitted through the wireless power transmitter. Power is directed via the metasurface to the wireless power receiver. The metasurface includes a plurality of coupled resonators being configured and arranged to shape a magnetic near field distribution from a transmitter toward the wireless power receiver. The plurality of coupled resonators includes a non-uniform impedance distribution pattern to provide the shape of the magnetic near field distribution.

The non-uniform impedance distribution pattern can be predetermined according to a predetermined position and distance relationship between a receiver and a transmitter.

The non-uniform impedance distribution pattern can be adjustable. Adjustment can be accomplished by changing the impedance and coupling of one or more of the coupled resonators to set a desired shape of the magnetic near field distribution.

The above features enable a system for wireless power transfer, as well as various methods and devices for wireless power transfer via a metasurface.

The metasurface for wireless power transfer can be a passive device, and therefore does not need any power supply itself or power electronic circuits to operate. Therefore, it can be made thin, light weight, and low-cost. The metasurface can serve as a disposable wearable device and provide improved power for implanted biomedical devices. Due to low cost, the metasurface itself can be a one-use device, beneficial in the medical industry as a guard against infection and virus transmission. Preferred metasurfaces provide transmission efficiency that is greatly enhanced compared to a comparable WPT system without the metasurface. For low power devices such as medical implants, magnetic power from the radiofrequency waves directed and enhanced by the present metasurfaces.

Experiments demonstrating principles and operation of example embodiments were conducted. A first set of experiments included a square array of strongly coupled resonators with different compensating capacitors. By controlling the impedance of each resonator, the metasurface can redistribute the magnetic fields in any desired manner. One can demonstrate its applications in reducing field leakage, improving WPT efficiency and compensating variance in the coupling coefficients of multiple receivers at the frequency of 200 kHz, compatible with the most commonly used WPT standard—Qi. The metasurface is highly robust to physical distortions; therefore, it can be made as a wearable device to feed power, for example, to implanted medical devices. Using a 3D unit cell design, the metasurface shows controllability of not only the intensity but also the orientation of the non-radiative magnetic field.

For lower frequency applications (100-200 kHz with Qi standard), in preferred embodiments, the impedance of each unit cell can be dynamically tuned by electrically switching between capacitors. For higher frequency applications, the capacitor becomes unnecessary with a preferred capacitor-free design. The impedance of each unit cell can be tuned by switching between multiple metal rings. Once the ring resonators are connected, the equivalent width becomes larger and the impedance becomes lower.

The experiments used ring resonators. Other shaped resonators can be used, for example, spiral resonators, square resonators, and hexagon resonators. Experiments demonstrate field distribution formed by strong near field coupling between the resonators.

A preferred application is to WPT systems where the receivers are medical implants. Generally, the invention provides a metasurface that functions as a passive device that can direct magnetic power to the receivers of the charge devices, including both implanted devices, e.g. pacemakers, and other devices, e.g., cell phones.

Preferred embodiments of the invention will now be discussed with respect to experiments and drawings. Broader aspects of the invention will be understood by artisans in view of the general knowledge in the art and the description of the experiments that follows.

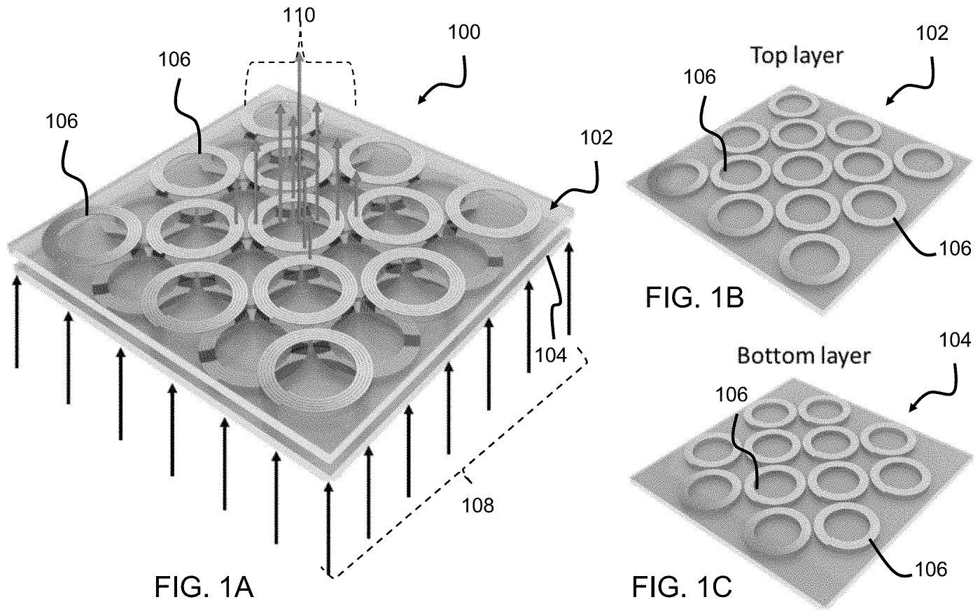

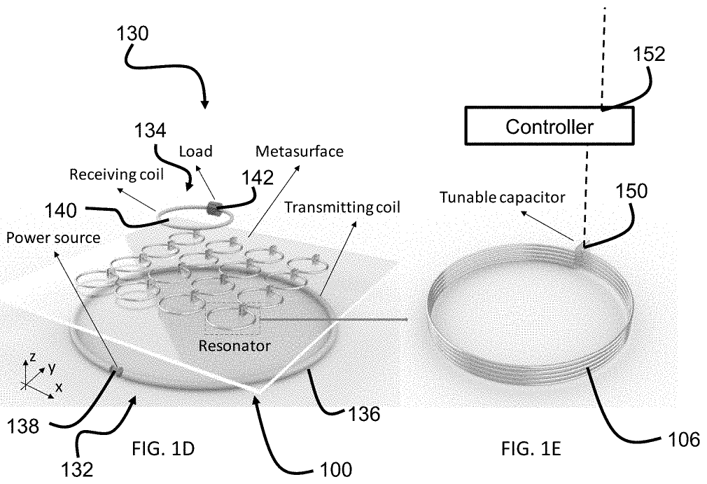

FIGS. 1A-1C show a preferred wearable metasurface 100. The meta surface 100 has two insulated support layers 102 and 104, shown bonded together in FIG. 1A. Each of the layers 102 and 104 supports and insulates a plurality of coupled resonators 106. The resonators 106 are configured and arranged to receive a magnetic near field distribution 108 from a transmitter and produced a shaped field 110 toward a target receiver. The resonators 106 in the two layers 102 and 104 preferably are offset from each other but have some overlap when viewed in the direction of the field lines of the field 108. Such partial overlap between the resonators can increase their coupling.

The field 110 in the example is a more narrowly focused and centered field than the received field 108. The plurality of coupled resonators includes a non-uniform impedance distribution pattern to provide the shape of the magnetic near field distribution of the field 110. This enhanced magnetic field 110 is controlled by the impedance distribution of the unit cells 106 and can therefore be centered on the region-of-interest targeting WPT receiver(s).

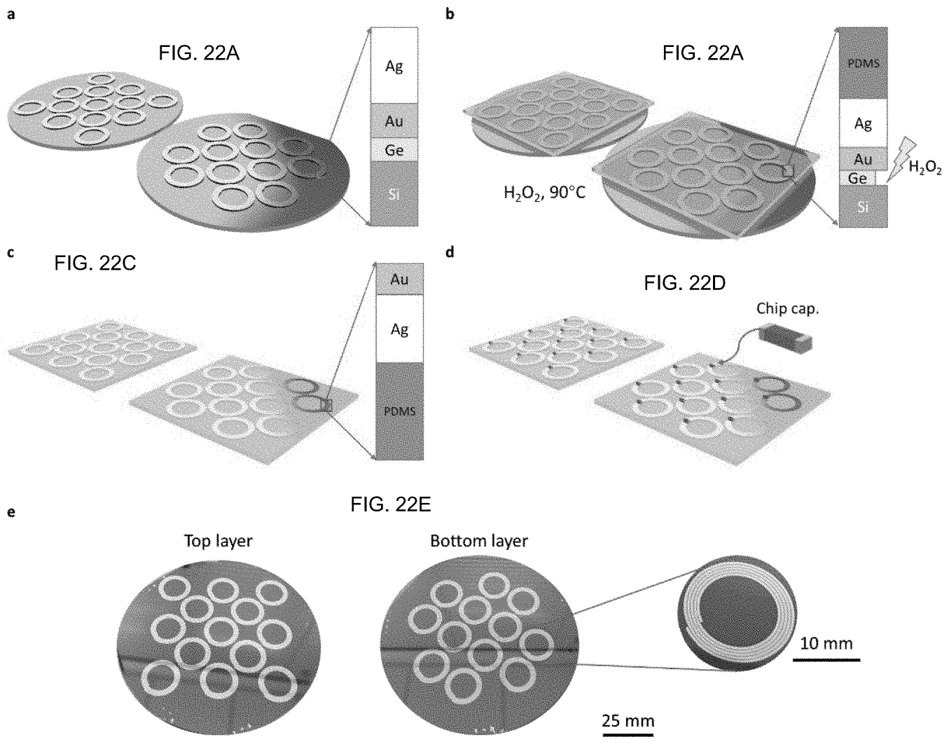

While the example preferred metasurface 100 includes two layers 102 and 104, more layers can be added and can improve performance as a trade-off with more complex fabrication. A benefit to additional layers is that one can further reduce the unit cell-to-unit cell separations. Lower separations lead to a stronger near field coupling between the unit cells and therefore, higher ability to reshape the magnetic field. This approach may be beneficial for lower-frequency metasurfaces, for example for WPT at Qi standard, when the coupling with a single layer or dual-layer design is suboptimal. The minimum period for a single or dual layer design is (D+Sₘᵢₙ)/\sqrt{2}, where D is the outer diameter of the unit cells, Sₘᵢₙ is the minimum separation in the same layer considering the fabrication difficulty, which can be ˜0.1 mm based on the fabrication techniques discussed with respect to FIGS. 22A-22E, but can be less with commercial foundry capabilities to execute that process. The minimum separation for a four-layer design is (D+Sₘᵢₙ)/2.

The example wearable metasurface 100 can have an overall thickness that makes it flexible and convenient to incorporate into various articles, e.g., clothing articles. Example thickness are preferably less than 20 mm, and more preferably less than about 5 mm. The size of the metasurface and the layers can have a diameter, for example, from 5 cm to 20 cm, and can have other shapes, such as oval or round.

The received magnetic field 108 can be supplied, for example, by an ambient radio-frequency field or a transmitter. The metasurface 100 reshapes the magnetic field 108 into the focused field 110, which contains an enhanced peak power density.

FIGS. 1D and 1E illustrate the metasurface 100 in a system 130 that includes a power transmitter 132 and a receiver 134. The power transmitter 132 includes a transmitting coil 136 with a power source 138. The receiver 134 includes a receiving coil 140 with a load 142. The metasurface 100 can be, for example, a square array (e.g., 21-by-21) of resonators 106, and is located in the near field above or on top of the power transmitter 104.

In an example experimental device, each resonator 106 was formed of 10 turns of AWG 20-Litz wire with a radius of 2 cm and periodicity of 2.2 cm in both the x- and y-directions and included a tunable capacitor 150. A controller 152 can be used to sets the compensation capacitor(s) 150 to set the non-uniform impedance distribution pattern according to information about the position between the power transmitter and the receiver. Each unit cell 106 can be treated as an LC resonator, and its impedance can be tuned by the value of the capacitor 150. The receiver 134 is located above or was placed on top of the metasurface 100 with a loading resistance of 5Ω.

With each unit cell 106 made with a spiral coil and a chip capacitor 150 that is in series with the coil. As an example, the spiral coil has 5 turns, a line width of 0.1 mm, a separation of 0.1 mm, and an outer diameter of 17.5 mm. the unit cell can be modeled as an LC resonator with the imaginary impedance, Im(Z), given by

$${ω}_{0} L - \frac{1}{{ω}_{0} C} .$$

Im(Z) can be tuned by the capacitance. The coupling between the unit cells in the same layer and in the two different layers can be modelled with Neumann's formula for mutual inductance between two closed circuits.

In experiments with the arrangement of FIGS. 1D and 1E, the metasurface 100 was placed between the power transmitter and the receiver 134, but can also be either attached to either (or both if the application/use permits) to enhance the transmission efficiency. Each resonator 106 is composed of a solenoid structure with finite turns and a tunable compensating capacitor. The magnetic field of such a resonator carries an energy of

$${E}_{r e s} = \frac{1}{2} \hat{L} {l}^{2} ,$$

where \hat{L} is the self-inductance of the resonator (assuming to be the same for all resonators). One can choose the square root of the energy as a measurement of the current of the resonator a=\sqrt{Eᵣₑₛ}.

Compared to the operational wavelength, which is around 1500 m for 200 kHz, the metasurface (around 10 cm in diameter) is far sub-wavelength. Therefore, the radiation of the resonators is negligible. The resonators, located close to each other (close to the minimum separation discussed above), forms a strongly coupled system through magnetic induction, and can be descried by coupled mode theory (CMT).

$$\frac{d}{dt} \vert A 〉 = ( i {ω}_{0} - Γ - K ) \vert A 〉 + \vert f 〉 , \qquad ( 1 )$$

where

$$\vert A 〉 = ( \begin{matrix}{a}_{1} \\ ⋮ \\ {a}_{m}\end{matrix} )$$

represents the current of all resonators, which describes the current distribution on the metasurface. wo is the operational frequency. Γ is the intrinsic loss of the system

$$Γ = \frac{1}{2 \hat{L}} ( \begin{matrix}{Z}_{1} & ⋯ & 0 \\ ⋮ & ⋱ & ⋮ \\ 0 & ⋯ & {Z}_{m}\end{matrix} ) ,$$

where Zₙ is the complex impedance of the n^{th} resonator,

$${Z}_{n} = {R}_{n} + i {ω}_{0} \hat{L} + \frac{1}{i {ω}_{0} {C}_{n}} . \\ K = - i \frac{{ω}_{0}}{2 L} ( \begin{matrix}{M}_{11} & ⋯ & {M}_{m 1} \\ ⋮ & ⋱ & ⋮ \\ {M}_{1 m} & ⋯ & {M}_{mm}\end{matrix} )$$

is the coupling matrix, where Mᵢₙ is the mutual inductance between the i^{th} and the n^{th} resonators, given by

$${M}_{in} \{ \begin{matrix}0 & i = n \\ \frac{{μ}_{0}}{4 π} {∮}_{\partial {Ω}_{i}} {∮}_{\partial {Ω}_{n}} \frac{1}{{r}_{in}} {dl}_{i} {dl}_{n} & i \neq n\end{matrix} \\ \vert f 〉$$

is the driving electrical potential from the magnetic field of the Tx coil,

$$\vert f 〉 = ( \begin{matrix}{F}_{1} \\ ⋮ \\ {F}_{m}\end{matrix} ) ,$$

where

$${F}_{n} = - i \frac{{ω}_{0}}{2 \hat{L}} {M}_{nTx} {a}_{Tx} .$$

$${Z}_{n} = \frac{2 \hat{L} {F}_{n}}{{a}_{n}^{′}} + i \frac{{ω}_{0} {{\sum }_{k = 1}}^{m} {M}_{kn} {a}_{k}^{′}}{{a}_{n}^{′}} . \qquad ( 3 )$$

M_{nTx} is the mutual inductance between the Tx coil and the n^{th} resonator, a_{Tx} describes the current of the Tx coil.

In the frequency domain, the current distribution can be described by the equation

(Γ+K)|A [symbol] =|f [symbol] (2)

To reshape the magnetic field, one can design the magnetic energy associated with all resonators, and thus, the current distribution on the metasurface.

One can set the targeting current distribution as

$$\vert {A}_{t} 〉 = ( \begin{matrix}{a}_{1}^{′} \\ ⋮ \\ {a}_{m}^{′}\end{matrix} ) .$$

By solving equation (2), the required impedance of the resonators is obtained:

For strongly coupled resonators, the second term in (3) dominates over the first term. Therefore, a metasurface is required that meets the following relationship,

$$Im ( {Z}_{n} ) = {ω}_{0} \hat{L} - \frac{1}{{ω}_{0} {C}_{n}} = \frac{{ω}_{0} {\sum }_{k = 1}^{m} {M}_{k n} {a}_{k}^{′}}{{a}_{n}^{′}} . \qquad ( 4 )$$

In equation (2)-(4), |A [symbol] is the current vector of the resonators, ω₀ is the operational frequency of the WPT system, Γ is the intrinsic loss matrix of the resonators, K is the coupling matrix of the resonators, |f [symbol] is the driving electrical potential of the resonators, Zₙ is the impedance of the n^{th} resonator, \hat{L} is the self-inductance of the resonator, Fₙ is the driving electrical potential to the nth resonator, aₙ′ is the targeting current of the n^{th} resonator, Mₖₙ is the mutual inductance between the k^{th} and n^{th} resonators.

By Neumann's Formula, one can calculate the coupling between all resonators of the metasurface and the Tx coil using a semi-analytical approach. Assume all resonators and the Tx coil have 10 turns, and have the resistivity of 10 Ω/1000 fts (close to the resistivity of AWG 20-Litz wire under 200 kHz). Note that a higher number of turns will lead to a stronger magnetic field but also a higher energy consumption due to the increased resistance. The number of turns is chosen for an optimized efficiency of the WPT system in balancing of the energy consumption and the targeting field shaping effect. The Tx coil, with an example radius of 12.5 cm, is in parellel and centered with the metasurface, with a separation of 20 cm in the z-direction. The example metasurface is made of 441 resonators in a 21-by-21 square array with a periodicity of 2.2 cm in both the x- and y-directions. All resonators have a radius of 2 cm and a self-inductance of 16 pH. Partial overlap between the resonators are designed to increase their coupling. One can tune the value of the compensating capacitors of the resonators to achieve the imaginary impedance given by equation (4). The highest achviable impedance is given by the self-inductance of the resonator as jω\hat{L}, which is around 20Ω. One can set a cut-off imaginary impedance as 20Ω, and higher value given by equation (4) will be set as 20 δ.

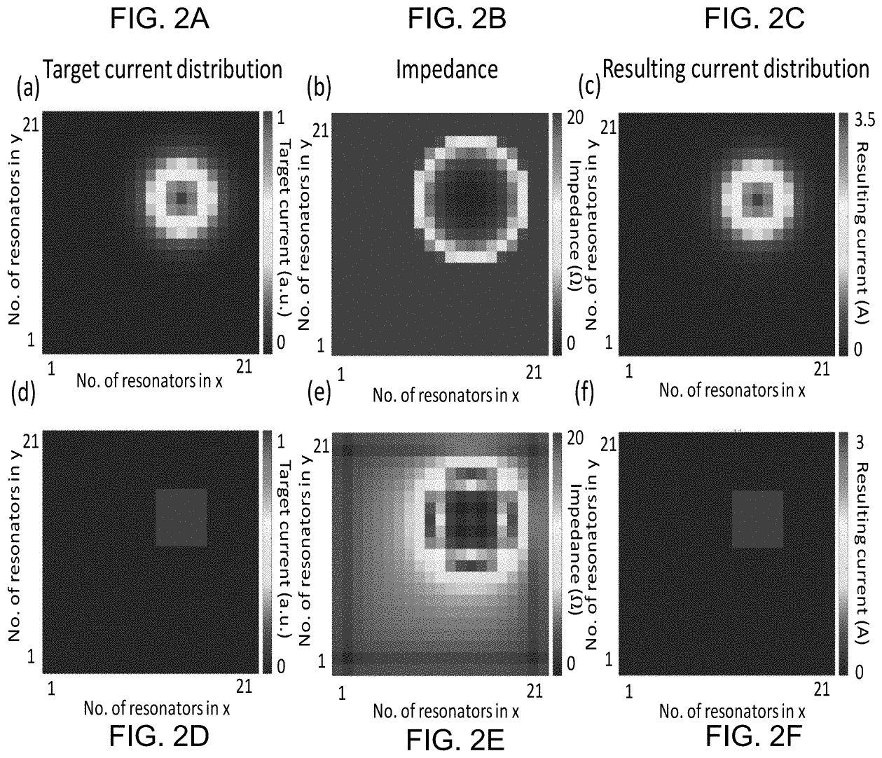

FIGS. 2A-2F show tuning the impedance of the metasurfaces that shapes the targeting current distribution. The targeting distributions are chosen as a Gaussian function and a uniform square function. The Gaussian function has FWHM of 5 periods (11 cm). The uniformed square function has a diameter across 5 periods, and with a peak intensity of 1 and minimum intensity of 0.1. The targeting current distribution is designed to be off-centered by 3 periods in both the x- and y-directions to demonstrate the metasurface's beam shaping capability, particularly, to redirect the beam's center and adjust the beam's size and shape. FIG. 2A shows targeting current on the metasurface with a Gaussian distribution, FIG. 2B the associated impedance distribution of the metasurface with 21-by-21 unit cells, and FIG. 2C the resulting current distribution excited by the transmitter 132 of FIG. 1D. FIG. 2D shows a targeting current on the metasurface 100 with a uniform distribution, FIG. 2E shows the associated impedance distribution of the metasurface, and FIG. 2F the resulting current distribution excited by the Tx coil 136 matches well with the designed current distribution in FIG. 2D.

The imaginary impedance distribution of all resonators for a Gaussian-beam with full width at half maximum (FWHM) of 5 periods and a uniformed square beam with diameter of 5 periods are shown in FIGS. 2B and 2D. Both of the beams are shifted by 3 periods in both the x- and y-directions. The calculated resulting current distribution with excitation of the Tx coil is highly similar to the targeting current distribution. The numerical calculation shows that the metasurface can create most desired current distribution and the required impedance distribution is independent of the excitation of the Tx coil. This phenonmenon can be proved by CMT as follows:

Due to the principle of reciprocity, Mᵢⱼ=Mⱼᵢ. As a result, the matrix Γ+K is Hermit, (Γ+K)^{†}=Γ+K. Set the intrinsic loss matrix as Γₜ, the targeting current distribution follows

$$( {Γ}_{t} + K ) \vert {A}_{t} 〉 = \frac{{R}_{R s}}{2 \hat{L}} \vert {A}_{t} 〉 . \qquad ( 5 )$$

The resulting current distribution |Aᵣ [symbol] also follows equation (2).

For the uniformed targeting current distribution

|Aₜ [symbol] [symbol] Aₜ|= [symbol] Aₜ|Aₜ [symbol] I. (6)

By solving Equation (2) & (5-6) one can can get that

$$〈 {A}_{t} \vert {A}_{r} 〉 = \frac{2 \hat{L}}{{R}_{R s}} 〈 {A}_{t} \vert f 〉 \\ and \qquad ( 7 )$$

$$〈 {A}_{r} \vert {A}_{r} 〉 = {( \frac{2 \hat{L}}{{R}_{R s}} )}^{2} \frac{〈 f \vert {A}_{t} 〈 {A}_{t} \vert f 〉}{〈 {A}_{t} \vert {A}_{t} 〉} . \qquad ( 8 )$$

Therefore, the correlation between the targeting current distribution and the resulting current distribution is 1.

$$corr ( {A}_{r} , {A}_{t} ) = \frac{\vert 〈 {A}_{t} \vert {A}_{r} ) \vert}{\sqrt{〈 {A}_{r} \vert {A}_{r} 〉 〈 {A}_{t} \vert {A}_{t} 〉}} = 1 \qquad ( 9 )$$

Γₜ is the intrisic loss matrix, K is the coupling matrix, R_{Rs} and L are the resistance and self-inductance of the resonators (assumed to be same for each resonator), |Aₜ [symbol] is the targeting current distribution, |f [symbol] is the driving electrical potential of the resonators, and |Aᵣ [symbol] is the resulting current distribution.

The above theory shows that the resulting current distribution will be same as the targeting current distribution for a unitformed targeting current distribution. As the coupling coefficients between the neighboring resonators are dominant in the coupling matrix, for quasi-uniform targeting current distribution with neglible variation between the neighboring resonators, the metasurface can also achieve a good magnetic beam-shaping effect. The neighboring resonators are the immediately connecting resonators in the x-y plane of a single layer design. For a dual-layer or four-layer design, they are in different layers.

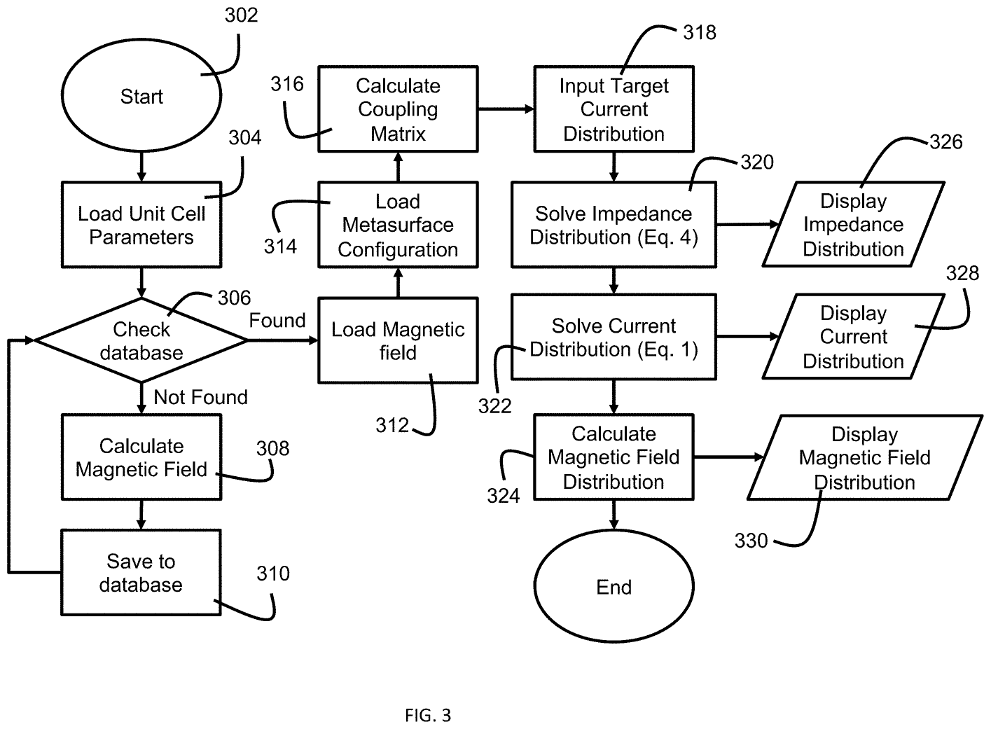

Equation (4) forms the basis for a controller, which can be implented via a program to compute the near field coupling between the unit cells and visualize the magnetic field distribution with existence of the metasurface. FIG. 3 shows the flowchart of the program.

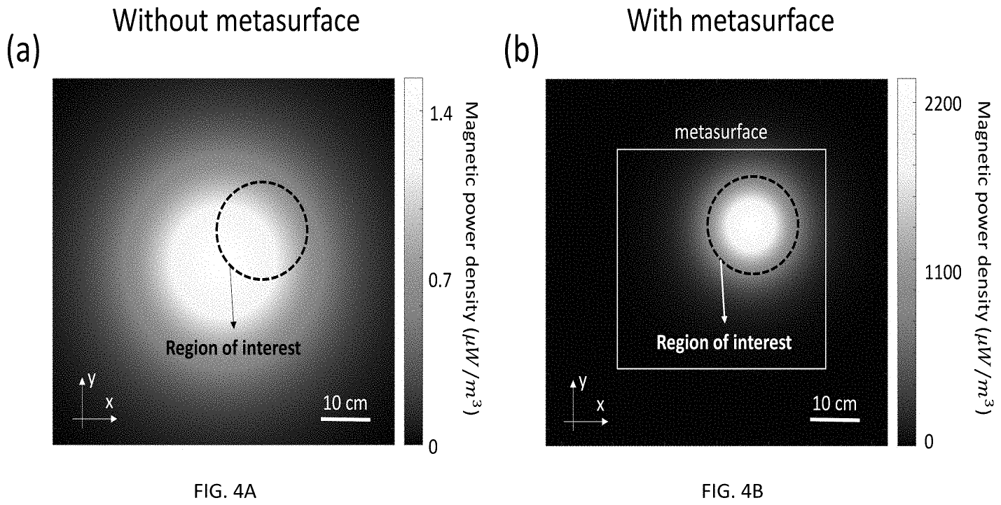

In FIG. 3, the program is started 302 and unit cell parameters are loaded 304. The unit cell parameters can include size, turns of the x-, y-, z-resonator in each orientations (x-, y-, z-), periodicity, and the self-inductance of the unit cell, A check 306 is made of a database of stored unit cell parameters to see if magnetic field parameters are calculated for the unit cell parameters. If not, then the magnetic field is calculated 308 and stored 310 in the database, and then loaded 312 by the program. A configuration of the metasurface is also loaded 314. The configuration can include the number of resonators, the separation between resonators, the number of layers, and the offset/overlap between resonators in the layers. The coupling matrix and magnetic field of the metasurface is then calculated 316 based on the parameters of the resonator and the metasurface-configuration. A targeted current distribution is input 318. This can be a Gaussian function similar to FIG. 4B. There is no need to provide a focal plane as the magnetic near field cannot be “focused” in the z-direction. Providing the region-of-interest with a center location and receiver's size is enough, and then impedance distribution for a targeting current distribution is solved with Equation (4) in 320, and the resulting current distribution is calculated 322 with Equation (1) and magnetic field is calculated 324. The respective calculated impedance, current distribution and magnetic field distribution can be displayed in steps 326, 328 and 330, though such display was primarily used for experimental observation purposes. The coupling relationship between all resonators calculated in 324, e.g. hundreds of unit cells, can be calculated semi-analytically based on Neumann's formula: first calculate the magnetic vector potential generated by one current source, then linearly integrate over the other path to get the magnetic flux. The program is much more efficient compared to the finite element method (FEM), which makes the design and optimization of a metasurface with hundreds or thousands of elements possible. The program can include routines for two classes, one class is for a planar metasurface, and one class is for a curved metasurface. Both can efficiently compute the coupling matrix, solve the impedance distribution based on the targeting current distribution, calculate the magnetic field distribution, and calculate the WPT transfer efficiency.

After solving the current distribution, one can calculate the magnetic field distribution in 324 by considering the contribution of all the resonators and the Tx coil with the theoretical magnetic field distribution of a round current loop. The magnetic power density is given by

$${u}_{B} = \frac{1}{2 {μ}_{0}} {\vert B \vert}^{2} , \qquad ( 10 )$$

where u_{B} is the magnetic power density, μₚ is vacuum permeability, and B is the magnetic flux density.

One can assume the targeting region of interest is off-center by three periods in both the x- and y-directions, which is located at 10 cm above the metasurface with a diameter across 5 periods.

FIGS. 4A and 4B respectively show magnetic power density without and with the metasurface. The targeting current distribution is chosen as a Gaussian function with a FWHM of 5 periods and off-center by 3 periods in both the x- and y-directions. Without the metasurface in FIG. 4A, only 7.62% of the magnetic power generated by the Tx coil falls in the region of interest. With the metasurface in FIG. 4B, 57.1% of the magnetic power falls into the region of interest, demonstrating that the metasurface can redistribute the magnetic field and significantly enhance the transmitted power in the targeting region.

Single Receiver Example.

Once a receiving coil (Rx coil) is placed in the region of interest, it will capture power from the magnetic field. One can use a Rx coil with a radius of 5 cm, 10 turns, and a resistivity of 32 Ω/1000 fts (close to the resistivity of AWG 25-Litz wire under 200 kHz). One can consider the coupling between all resonators, Tx coil, and Rx coil, and calculate the current with CMT. The efficiency is given by

$$η = \frac{{I}_{R x}^{2} {R}_{L}}{{I}_{R x}^{2} ( {R}_{L} + {R}_{R x} ) + {\sum }_{j = 1}^{M} {I}_{Rs , i}^{2} {R}_{R s} + {I}_{T x}^{2} {R}_{T x}} , \qquad ( 11 )$$

where I_{Rx}, is the current of the receiving coil, R_{L} is the loading resistance, R, is the resistance of the receiving coil, I_{Rs,i} is the current of the i^{th} resonator of the metasurface, R_{Rs} is the resistance of the resonators, which is assumed to be the same for each resonator, I_{Tx} is the current of the transmitting coil, and R is the resistance of the transmitting coil.

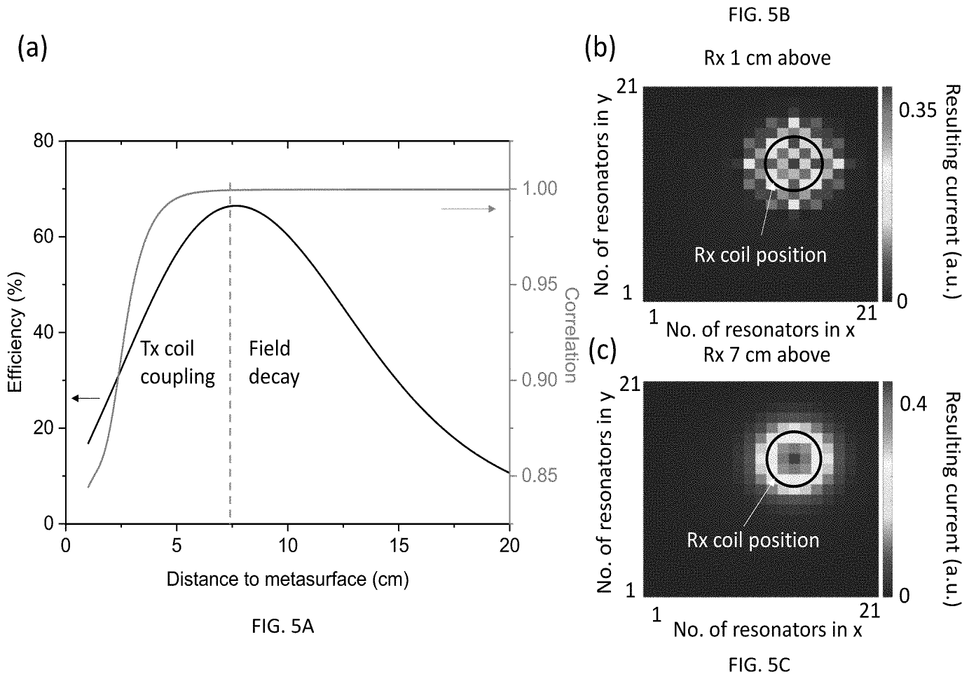

FIGS. 5A-5C respectively show the calculated efficiency as a function of the distance between the Rx coil and the metasurface, resulting current distribution, and cross-correlation between the targeting current distribution and the resulting current distribution with different Rx coil-metasurface distance. FIG. 5A shows that the correlation between the resulting current distribution and the targeting current distribution increases with the Rx coil-metasurface distance and approach to 1 with a distance larger than 5 cm. FIG. 5B shows that current distribution is distorted when the Rx coil is close, and FIG. 5C shows the approach to the targeting current distribution when the Rx coil is far. Close and far are defined with respect to an optimal distance of separation between the Rx coil and the metasurface. This optimal distance of separation is discussed next.

An optimal efficiency does not occur immediately adjacent the metasurface but at a certain distance, which one can refer to as an optimal distance. As the Rx coil moves further away from the optimal distance, the magnetic field decays, and thus the efficiency decays. Such decay is unavoidable from a non-radiative field. As the Rx coil moves closer to the metasurface than the optimal distance, the strong non-uniform coupling from the Rx coil disrupts the current distribution on the metasurface, forming a sub-optimal field-shaping at the region of interest, which reduces the efficiency. As a result, for each metasurface design, there exists an optimal distance between the Rx coil and the metasurface in the magnetic near field to achieve a high efficiency.

Given the numerical numbers from our example design consistent with FIG. 1D and discussed above, the optimal distance is at ˜7.5 cm above the metasurface with a Gaussian beam with FWHM of 5 periods. This optimal distance is tunable by the FWHM of the Gaussian beam. One can observe that the optimal distance can be influenced by the target beam shape. Primary factors that affect the optimal distance include the number and periods of the resonators, operational frequency of the WPT system, size of the targeted magnetic fields, and the loading impedance of the receiver.

One can define the Rx coil-metasurface distance for the optimal efficiency as the working distance of the metasurface. In addition to efficiency, one can use cross-correlation between the targeting current distribution and the resulting current distribution as a measure of the beam-shaping quality. The correlation is defined as

$$corr ( {A}_{r} , {A}_{t} ) = \frac{\vert 〈 {A}_{t} \vert {A}_{r} 〉 \vert}{\sqrt{〈 {A}_{r} \vert {A}_{r} 〉 〈 {A}_{t} \vert {A}_{t} 〉}} , \qquad ( 12 )$$

where |Aₜ [symbol] is the targeting current distribution and |Aᵣ [symbol] is the resulting current distribution.

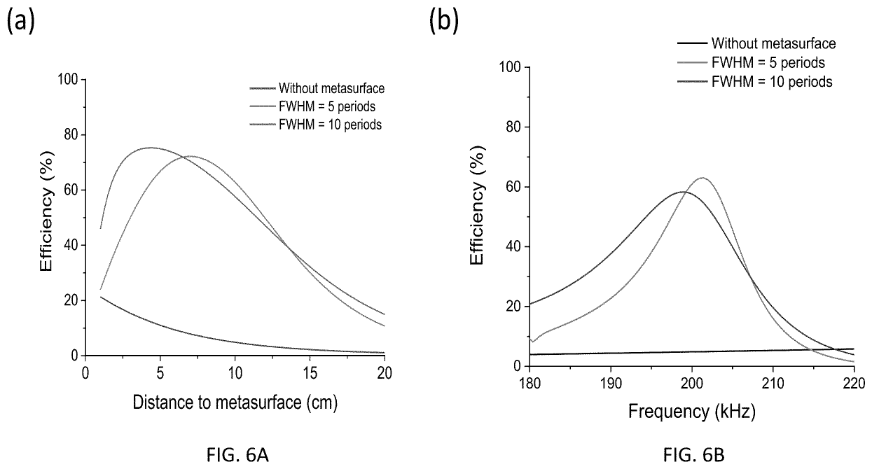

One can calculate the enhanced efficiency with different FWHM of a targeting Gaussian beam. FIGS. 6A and 6B respectively show the influence of FWHM of the targeting current distribution on the working distance and operational bandwidth. FIG. 6A plots efficiency as a function of distance between the Rx coil and the metasurface. FIG. 6B plots efficiency as a function of operational frequency with the Rx coil-metasurface distance of 10 cm. All targeting beams are centered. As shown in FIG. 6A, a relatively larger beam leads to a shorter working distance and slower decay rate to the right of the optimal distance. Moreover, as shown in FIG. 6B, in a mid-range (the distance between the metasurface and the Rx coil), the larger beam also leads to a slightly lower enhancement in efficiency but a boarder operational bandwidth. One should choose the FWHM of the targeting current distribution according to the designed working distance and the operational bandwidth.

Multi-Receiver Example.

Power can be controlled to multiple receivers, both with the amount of power and location of the receivers. To boost the transmission with multiple receivers, one can use the metasurface to shape multiple beams to the locations of each receiver. Most interestingly, by controlling the intensity of the beams, one can control the ratio of the power delivered to each device and compensate an unbalanced coupling condition.

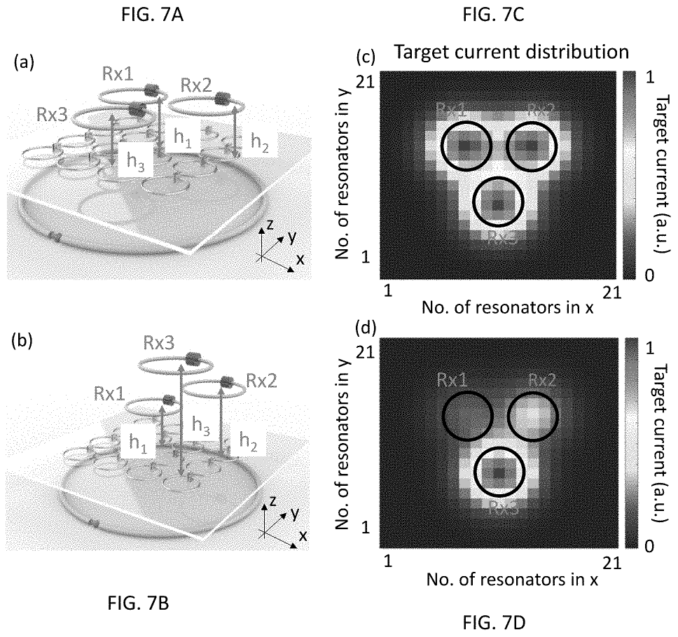

In the following, consider two scenarios: (1) uniformly coupled devices and (2) non-uniformly coupled devices, as shown in FIGS. 7A and 7B, respectively. In both cases, the three receivers Rx1, Rx2 and Rx3 are in parallel with the metasurface. The uniformly coupled Rx coils of FIG. 7A are all placed with the height of 10 cm above the metasurface, and the non-uniformly coupled Rx coils of FIG. 7B are placed 7 cm, 12 cm, and 17 cm above the metasurface. The heights of all Rx coils are above the optimal distance so no significant distortion to the current distribution will be induced by the Rx coils.

The x-y coordinate of the Rx coils are [−3 periods, 3 periods], [3 periods, 3 periods], and [−3 periods, 0] respectively. For equal power distribution among the three receivers, the targeting current distribution includes three Gaussian beams with equal intensities, FWHM of 5 periods, and x-y center locations same as the three Rx coils, as shown in FIG. 7C. For equal power distribution, to compensate the non-uniform coupling, the intensities of the three Gaussian beams are chosen as 0.186:0.366:1, as shown in FIG. 7D.

For uniformly coupled devices, the transfer efficiency to each device can be evenly increased by more than 6 folds using three targeting Gaussian beams with the same intensity (FIG. 7C). All receivers have the same Rx coil with a radius of 5 cm and a loading resistance of 5Ω. One can use the intensity ratio of the Gaussian beams to control the ratio of power feeding into each device. As the receiving power is proportional to the magnetic flux captured by the Rx coil, the power ratio is approximately to the square of the intensity ratio. For example, a targeting intensity ratio of 0:0.4:1 corresponds to a targeting power ratio 0:0.4²:1². While preserving the overall efficiency, the power of each device can be tuned from less than 2% to over 50% of the total input power. Table 1 shows the numerical results for this scenario.

TABLE 1
Three receivers with uniform coupling. By varying the intensity
ratio among the three Gaussian beams, one can control the
power distribution among the users. The receiving power of
one receiver can be various from 2.08% to 50.64% of the input
power with minimum change of the total efficiency.

| | Case | | | |
|---|---|---|---|---|
| | Receiver | Receiver | Receiver | Total |
| | 1 power | 2 power | 3 power | efficiency |
| 0 (no metasurface) | 3.11% | 3.11% | 3.78% | 10% |
| 1:1:1 | 23.23% | 23.23% | 20.93% | 67.39% |
| 0:1:1 | 1.94% | 31.61% | 31.73% | 65.28% |
| 0:1:0.4 | 2.08% | 50.64% | 11.47% | 64.19% |

On the other hand, when multiple devices are not uniformly coupled to the metasurface, the unbalanced coupling condition will result in an unequal power division. In FIG. 7B, Rx 3 has the weakest coupling coefficient, while Rx 1 has the strongest coupling coefficient due to their different heights above the metasurface.

Without the metasurface, the load with Rx 3 will receive relatively more power (6.7%), while the one with Rx 1 will barely receive any power (1.48%). To solve this problem, one can design a current distribution with a stronger Gaussian beam toward the device with a weaker coupling, as shown in FIG. 7D. After compensation, the power distribution among receivers become more uniform (14.20:14.19:14.23) or (1.0007:1:1.002) by choosing a targeting intensity ratio of 0.186:0.366:1 of the three Gaussian beams. More evenly distributed power can be achieved by optimizing the ratios between targeting peak intensities of the Gaussian beams.

TABLE 2
Three receivers with non-uniform coupling. The metasurface
can compensate the power density at the specific location
to achieve a similar receiving power. No compensation
uses a targeting intensity ratio of 1:1:1, and with compensation
uses the ratio of 0.186:0.366:1.

| | Case | | |
|---|---|---|---|
| | Receiver | Receiver | Receiver |
| | 1 power | 2 power | 3 power |
| Without metasurface | 5.02% | 2.35% | 1.36% |
| No compensation | 50.4% | 13.46% | 4.10% |
| With compensation | 14.20% | 14.19% | 14.23% |

Geometric Distortion of the Metasurface.

A wearable device might be flexible for comfort and practicality. Specifically, the insulated support structure(s) such as 102 and 104 can be thin enough and made or material that permits flexing.

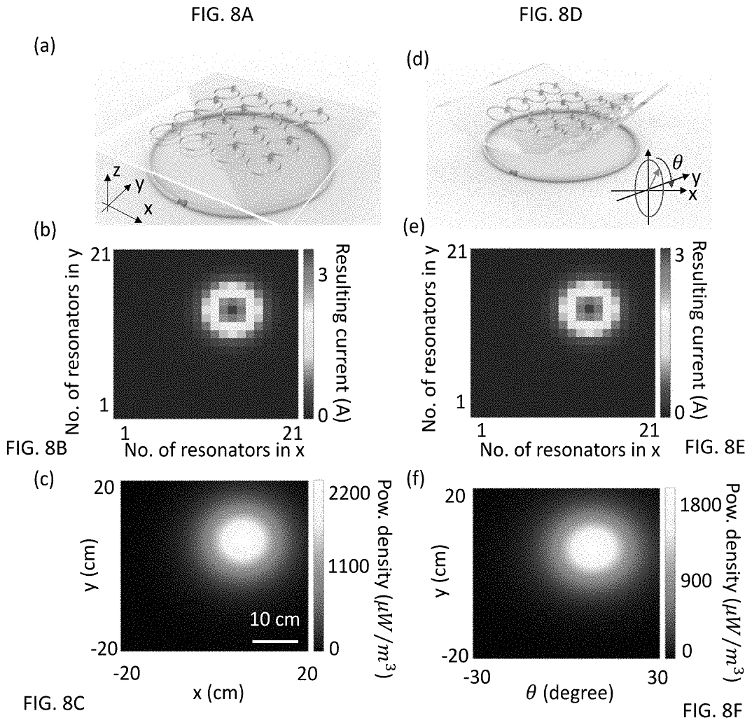

FIGS. 8A-F show a lack of negative performance influence of geometric distortion of a preferred metasurface. FIG. 8A shows the metasurface in a natural (non-flexed) state, FIG. 8B its current distribution, and FIG. 8C its magnetic power density at 10 cm above a planar metasurface. FIG. 8D shows the metasurface flexed by 60 degrees, FIG. 8E that the impedance configuration is not changed as shown by the current distribution and FIG. 8F that magnetic power density distribution 10 cm above the metasurface remains mostly unchanged.

Geometric distortion can potentially result in a change of the current distribution and thus the magnetic field. In equation (2), the coupling coefficients between the neighboring resonators are dominant in the coupling matrix. The coupling coefficient quickly attenuates to less than 10% of its value between the neighbouring resonators within 2 periods. Therefore, the current distribution largely depends on the coupling between the neighboring resonators. As the resonators are relatively small compared to the size of the metasurface, the relative position between the neighboring resonators is insensitive to the overall distortion. As an example, an experimental device included unit cells having a diameter of 4 cm and the metasurface has a size of 48 cm. Therefore, the ratio between unit cell's size and the overall size of the metasurface is 1/21, which is ˜5%. As shown FIGS. 8D-8F, the example surface which allows bending without neighbor resonators being moved to within 2 periods of each other and therefore provides insensitivity to the distortion.

Omnidirectional Metasurface.

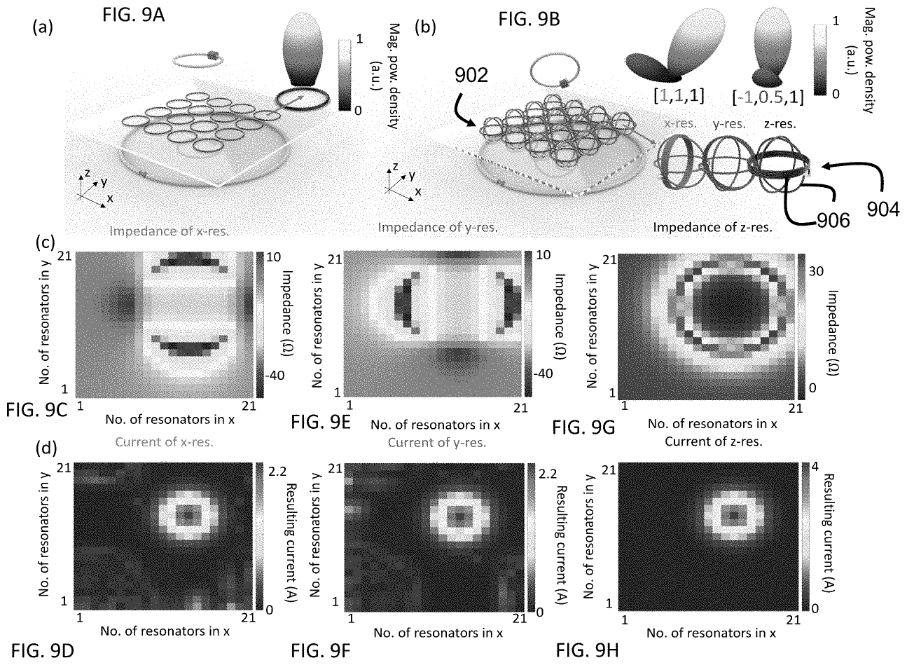

FIG. 9A shows a planar metasurface. FIGS. 9B and 9C-9H respectively show an omnidirectional metasurface 902 and impedance distributions to achieve uniform power densities at different angles. The omnidirectional metasurface 902 includes resonators 904 having coils 906 arranged in each of respective x, y and z planes. The angular power density is measured 10 cm away from the unit cell at different spatial angles. The omnidirectional unit cell can control the orientation of the magnetic field by its current distribution in the coils arranged in the different planes. With the impedance distribution in FIGS. 9C, 9E, and 9G), one can shape the directional Gaussian beam with the current distribution in FIGS. 9D, 9F and 9H. The targeting field vector is [1, 1, 1] (same current distributions for all the x-, y-, and z-resonators).

The planar unit cell geometry of FIG. 9A works well for generating the magnetic field in the z-direction, which is suitable for Rx coils placed in parallel with the metasurface. However, in some applications, the axes of a wearable metasurface may be necessarily non-parallel, e.g., bound by the body shape of a patient, and the Rx coil of an implanted medical device may not be necessarily in parallel with the metasurface but with a tilt angle θ. The captured power from a tilted Rx coil will drop in the order of cos(0)². For example, once the receiver is titled by 54.7° (with the normal vector of [1,1,1], the receiving power will drop by about 66.7% with a planar metasurface. FIG. 9B solves this issue with a resonators 906 that each form a 3D unit cell, which consists of coils in x-, y-, and z-directions with different ratios. The resonator 906 can be formed of three resonators connected in series with a compensating capacitor for each unit cell. Using the 21×21 unit cell metasurface example, this forms an omnidirectional metasurface with 1323 resonators (21×21×3) (3 represents the x-, y-, and z-orientations). Each resonator 906 has 10 rings in its dominant orientation and 2 rings in each of the other two orientations. One can use the same radius, resistivity, and periodicity as in the previous setting for the resonators. For example, resonator x has 10 turns in the x-direction, 2 turns in the y-direction, and 2 turns in the z-direction. One can define the magnetic field vector as the ratio of current of the resonator x, y, and z. By shaping the magnetic field vector, one can control the orientation of the magnetic field as its pointing direction, and therefore optimize the efficiency for a receiver with any random orientations.

With reference to FIGS. 9D, 9F and 9H, the targeting current distribution is a Gaussian beam with FWHM of 5 periods, center location of [3 period, 3 period] in the x-y coordinate, and with the magnetic field vector of [1, 1, 1]. In other words, targeting intensity of the x-, y-, and z-resonators are the same. The targeting magnetic field points toward [1, 1, 1] direction, therefore, receiving power of a Rx coil facing [1, 1, 1] will be optimized. One can calculate the coupling between all the 1323 resonators and solve the impedance distribution with equation (4). The impedance distribution for the x-, y-, and z-resonators are shown in FIGS. 9C, 9E and 9G, respectively. With a parallel-placed Tx coil 20 cm below the metasurface, one can form the current distribution shown in FIGS. 9D, 9F and 9H. The current generated by the z-resonators has the strongest amplitude. This is because the driving field generated by the parallel-placed Tx coil is mainly in the z-direction. The strong mismatch between the targeting current distribution and the driving field results in the error of the resulting magnetic field vector. However, the Gaussian current distribution is well-shaped for the orientations. The error in the magnetic field vector can be compensated by increasing the x- and y-component of the targeting field vector.

### Experiments

Experiments demonstrated an active metasurface for controlling the non-radiative magnetic fields. The metasurface can generate a desired non-uniform near field magnetic field distribution by having a predetermined impedance pattern or by tuning the impedance of each resonator. A bendable wearable device is supported by the experiments and can wirelessly charge implanted medical devices operating at 200 kHz with enhanced efficiency. One can design the impedance distribution of the unit-cell that can achieve any desired current distribution using the coupled mode theory. For strongly coupled resonators, the impedance distribution is independent of the excitation magnetic field from the Tx coil. Therefore, one can solve the impedance distribution only with the periodicity and size of the resonators composing the metasurface. The metasurface and methods of the invention have advantages in WPT, including improved efficiency, controllable power division among multiple users, and omni-directional power transfer. Further, as the coupling of the metasurface is mainly formed between the neighbouring resonators of the metasurface, the current distribution is robust to geometric distortions of the metasurface, allowing for the metasurface to be used as a wearable device. Any low power (below 10 W) devices can be charged with the metasurface. Such as phones, laptops, pads, watches, earphones, medical devices such as pacemakers, capsule endoscope, and insulin pump.

Capacitor-Free Metasurface

For strongly coupled resonator, the impedance predicted by the coupled mode theory follow

$$Im ( {Z}_{n} ) = \frac{{ω}_{0} {\sum }_{k = 1}^{m} {M}_{k n} {a}_{k}^{′}}{{a}_{n}^{′}} , \qquad ( 13 )$$

where Zₙ is the complex impedance of the unit cell, Mₖₙ is the mutual inductance between k^{th} and n^{th} unit cell, aₙ′ is the targeting current of the n^{th} unit cell. The unit cell of the capacitor-free metasurface consists of numbers of co-centered metal rings. The impedance of the unit cell is determined by the width and separation of the rings, which is fixed for a particular design. This provides a metasurfaces can be made low cost to target a specific application with a defined relationship between the receiver and the transmitter, e.g., a specific medical device. To provide a specific design, the impedance distribution is decided by the receiver(s)' position(s) and size(s). One or more Gaussian beams fitting with the positions and sizes are determined. Then, the impedance distribution is calculated with Eq. (13).

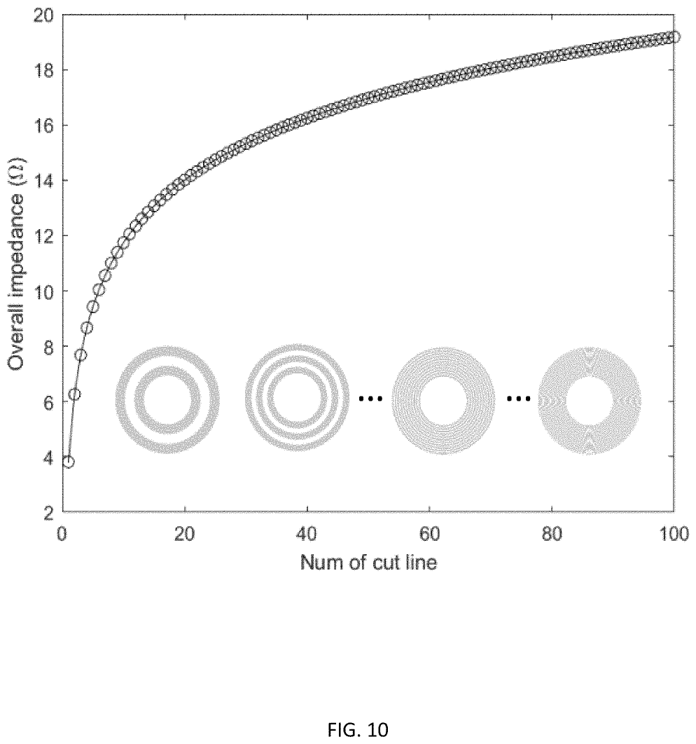

FIG. 10 shows an impedance curve with different number of resonator rings. The impedance is calculated at 100 MHz, the diameter of the external rings is fixed at 8 mm, the total width and gap is fixed at 2 mm.

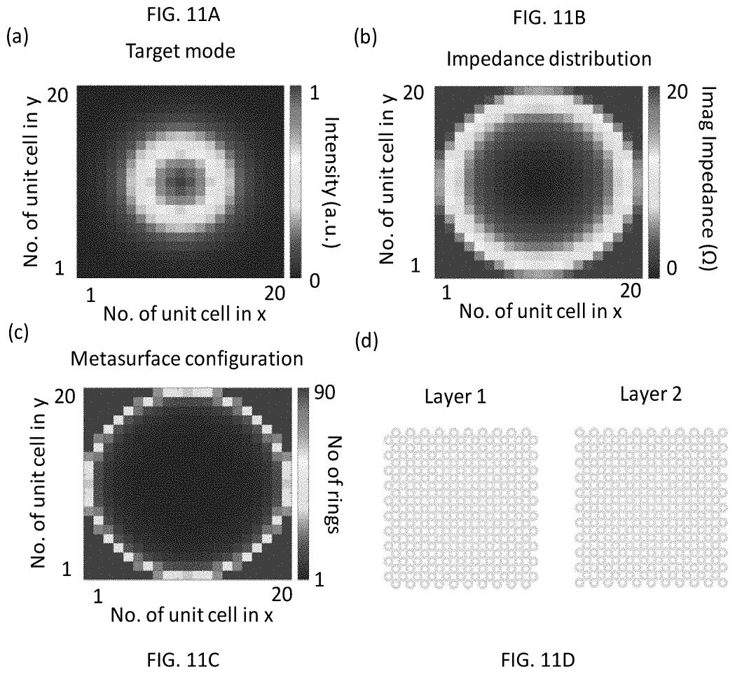

FIGS. 11A-11D illustrate properties of an example capacitor-free metasurface. FIG. 11A is the targeting current distribution. FIG. 11B is the calculated impedance distribution. FIG. 11C is the metasurface configuration determined by the impedance curve in FIG. 10. FIG. 11D illustrates two layers of the capacitor-free metasurface.

With the impedance curve of FIG. 10, one can map the calculated impedance distribution into the configuration of the unit cells in FIG. 11C. Some overlap space is created between the unit cells to create positive and high coupling coefficient between them.

Besides greatly enhancing the efficiency, the metasurface can achieve ultra-broad bandwidth over 50 MHz. Both the impedance of the unit cell and the targeting impedance are proportional to the operational frequency, therefore, the metasurface can work in a broad bandwidth. The current distribution can be well-formed to a Gaussian beam with FWHM of 5 periods. The phase of the current distribution at the center of the beam is close to 90 degrees, which demonstrates that the metasurface can form resonance at this operational frequency. The lower bound of the efficiency is determined by the intrinsic resistivity of the unit cell, and the higher bound of the efficiency is determined by the radiation of the unit cell. The rated power efficiency can be improved for over 10 folds in an over 50 MHz of frequency.

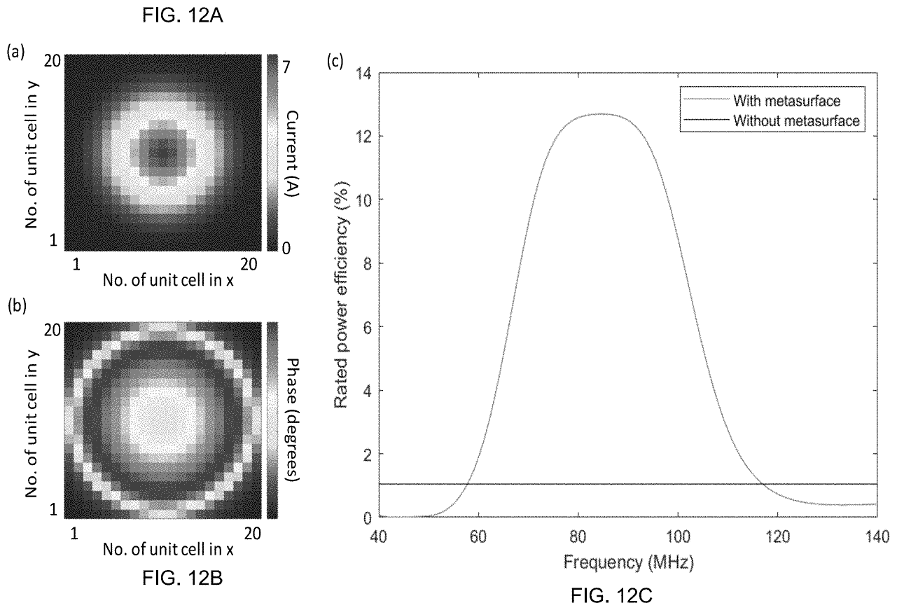

FIGS. 12A-12C concern efficiency vs frequency of the capacitor-free metasurface. FIG. 12A shows distribution on the metasurface. FIG. 12B shows phase on the metasurface. With the current distribution calculated at 100 MHz, FIG. 12 C shows rated power efficiency of a receiver coil with and without the metasurface. The rated power efficiency is well below 2 without the metasurface and peaks around 13% with the metasurface. The receiver is in distance of 5 cm to the metasurface, diameter of 1 cm, number of turns of 10, and load resistance of 1Ω.

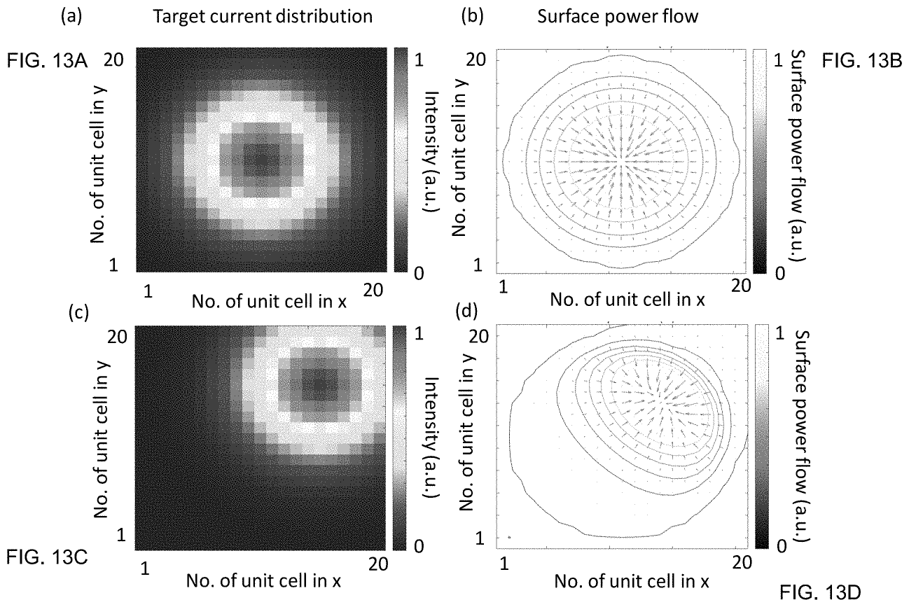

FIGS. 13A-13D illustrate surface power flow of the metasurface. FIG. 13A shows centered Gaussian beam with FWHM of 5 periods. FIG. 13B show the surface power flow and contour line of the power distribution of on the metasurface with the targeting current distribution in FIG. 13A. FIG. 13C shows a Gaussian beam with FWHM of 5 periods and offset in both x- and y-direction for 5 periods. FIG. 13D shows the surface power flow and contour line of the power distribution of on the metasurface with the targeting current distribution in FIG. 13C.

As shown by the information in FIGS. 13A-13D, the metasurface can efficiently collect energy through magnetic near field coupling and deliver it to the receiver. As the surface power flow is formed through near field coupling between the unit cells, the receiver can be in various distance to the metasurface. This feature is particularly beneficial for biomedical applications as the microimplants, which may be located at an indefinite depth to the skin. The distance can't be precisely specified and may change with patient movements.

The metasurface can be fabricated with photolithography, electron-beam metal deposition, and lift off. With a dual-layer photoresist, the unit cell of the metasurface is successfully fabricated. The metasurface can be made with two layers of unit cells with PDMS layer between them.

An example metasurface without capacitors was fabricated having unit cells with 26 and 12 rings. The metal thickness in the rings was about 1.3 μm. In example fabrications, the metal traces used to form the rings were 500 nm thickness of silver deposited with an electron beam evaporator.

### Additional Experiments—Proof-of-Concept Experiment of the On-Demand Magnetic Field Shaping and Enhancement to the Efficiency

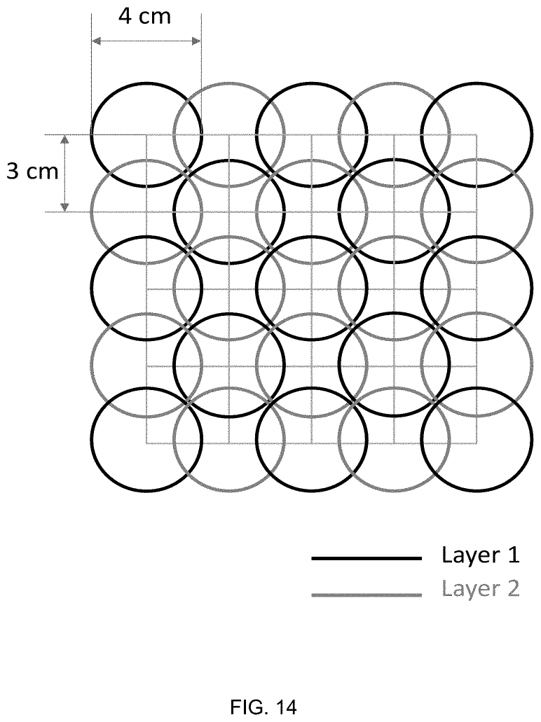

Here, one can choose the operational frequency of 190 kHz. Consider a small example metasurface with 25 resonators in a 5-by-5-array. Each resonator has a radius of 2 cm and number of turns of 5. The periodicity of the resonators is 3 cm in both x- and y-direction. The metasurface is formed with 2 layers of resonators with layer-gap of 0.7 cm. Some overlap space between the resonators is beneficial to generate strong coupling. To configure the metasurface in a most compact way, the resonators can be arranged in two layers in an interlaced manner. FIG. 14 illustrates this arrangement where the resonators in different layers appear to be interlaced when viewed from above or below the plane of the metasurface.

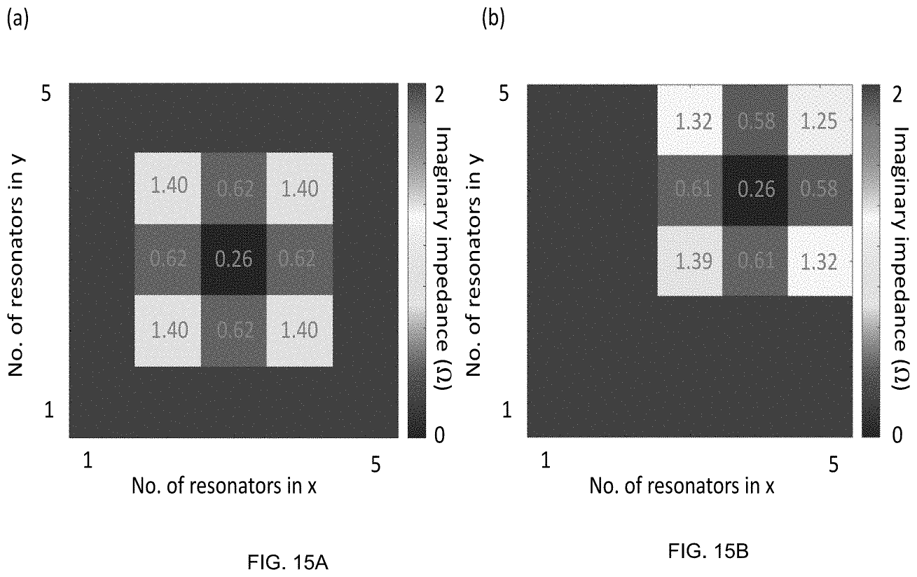

When forming Gaussian beam with FWHM of 2 periods (6 cm), the impedance distribution with the center location of [0, 0] and [1 period, 1 period] are shown in FIGS. 15A &15B, which is an impedance distribution to shape single Gaussian beam with different center locations.

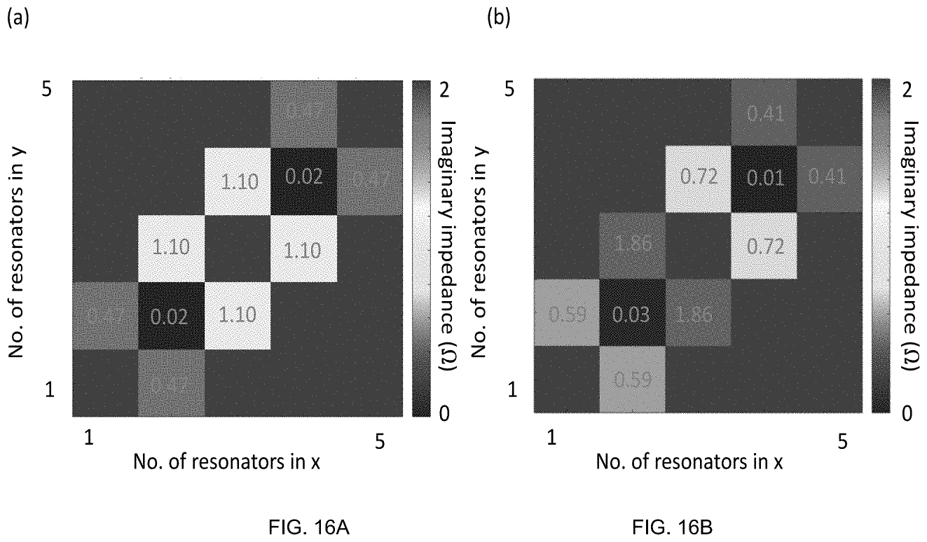

For dual-user case with the two Gaussian beams with 1:1 intensity and 1:0.5 (upper right beam to lower left beam) intensity, the impedance distributions are shown in FIGS. 16A and 16B.

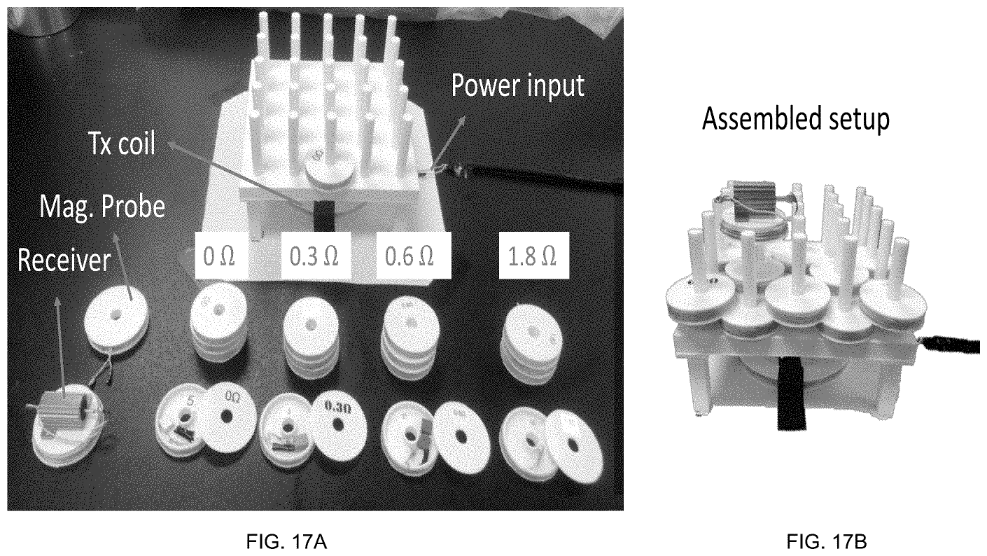

FIGS. 16A and 16B specifically shows the impedance distribution to shown two Gaussian beams with different intensities to approximately achieve the two scenarios, one only need the impedance value of 0 Ω, 0.3 Ω, 0.6 Ω, 1.8Ω, and inf Ω. FIGS. 17A and 17B illustrate a test device used in the experiments, in which resonators, transmitters and receivers were individually packaged in insulators and a test bed including poles for mounting and arranging the resonators, transmitters and receivers. As already noted above, the impedance of the resonator is given by

$$Im ( {Z}_{n} ) = {ω}_{0} \hat{L} - \frac{1}{{ω}_{0} {C}_{n}} , \qquad ( 14 )$$

\hat{L} is the self-inductance of the resonators. One can use a resonator with radius of 2 cm and number of turns of 5. The self-inductance of the resonator can be calculated with its measured resonance frequency fᵣₑₛ:

$$\hat{L} = \frac{1}{{( 2 π {f}_{r e s} )}^{2} \hat{C}} ,$$

where Ĉ is the capacitance of the compensation capacitor, typically around 0.4 μF. The self-inductance of the resonator one can use is around 1.74 μF. Cₙ is the capacitance of a variable capacitor. One can will use its capacitance to control the imaginary part of the impedance (impedance for short):

$${C}_{n} = \frac{1}{{ω}_{0}^{2} \hat{L} - {ω}_{0} Im ( {Z}_{n} )} .$$

At the operational frequency of 190 kHz, here are the corresponding relationship of some typical impedance value, the required capacitance, and the resonance frequency of the resonator.

TABLE 3
The impedance and resonance frequency of resonators with different
compensation capacitance. The resonators are wired with AWG
20 Litz wire with radius of 2 cm and number of turns of 5.

| Impedance (Ω) | Capacitance (μF) | Resonance frequency (kHz) |
|---|---|---|
| 0 | 0.39 | 190 |
| 0.3 | 0.47 | 170 |
| 0.6 | 0.54 | 155 |
| 2.2 | Inf (short end) | NA |
| inf | 0 (open end) | NA |

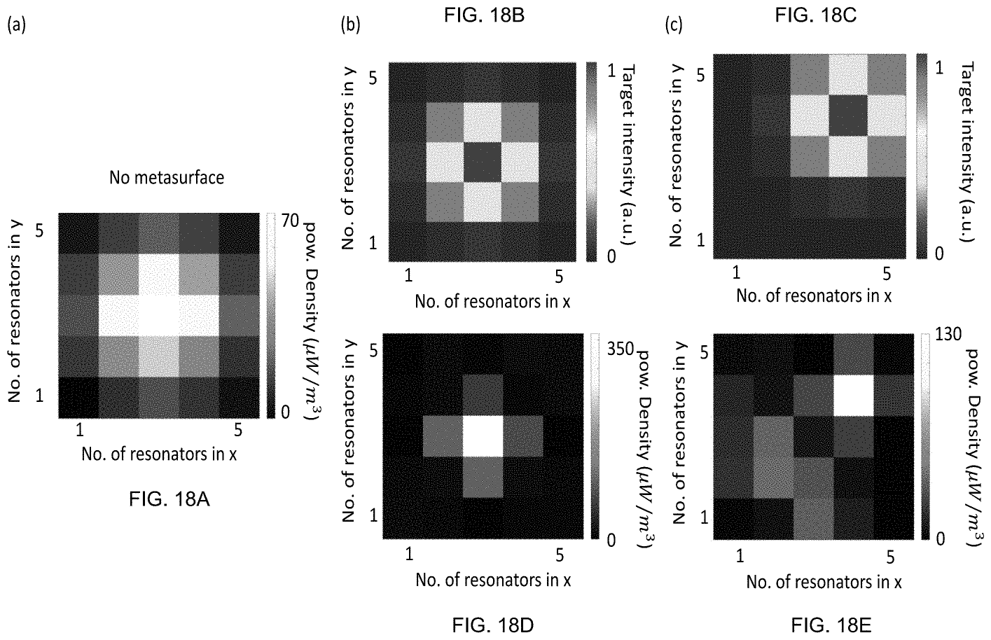

With the capacitance value shown in Table 3, one can use the test bed of FIGS. 17A-17B to construct resonators with patterns in FIGS. 18A-18E with the impedance of 0 Ω, 0.3 Ω, 0.6Ω, and 1.8Ω. For a resonator with the impedance of inf Ω, one can simply leave the position empty (no resonator). The test bed was used to construct series of resonators with different impedances, compensated Tx coil, receivers (compensated Rx coil with a load of 1Ω), and an open-end coil as magnetic field-probe. The metasurface is made with two layers of resonators in a designed impedance distribution.

In the test bed, each resonator has the radius of 2 cm, number of turns of 5, and periodicity of 3 cm in both the x- and y-direction. Tx coil has radius of 5 cm and number of turns of 10. Rx coil has radius of 2 cm and number of turns of 10. The metasurface is 5 cm away from the Tx coil, and 3 cm away from the receiver. The Tx coil is fed with a coaxial cable and driven by signal generator HEWLETT 33120A. The Tx coil, metasurface, receiver, and magnetic probe (when measuring magnetic power density) are placed parallel to each other. The signal is measured by oscilloscope Tektronix TDS 540C.

Single Receiver Case.

The targeting current distribution of a single Gaussian beam with FWHM of 1 period (3 cm) was used. Comparing the magnetic power density with and without the metasurface in FIGS. 18A-18E, the peak magnetic power density is increased from 72.02 μW/m³ to maximum 361.06 μW/m³ (with a centered beam in FIG. 18B. Therefore, the receiving power can be enhanced for over 5-folds with the same feeding current. Moreover, the center position of the beam can be shifted. The power density at the location of (1 period, 1 period) is increased from 39.34 μW/m³ to 139.40 μW/m³ (with a shifted beam in FIG. 18C). With the help of the metasurface, receiver at all locations can receive a much stronger power. Therefore, position-free WPT can be achieved.

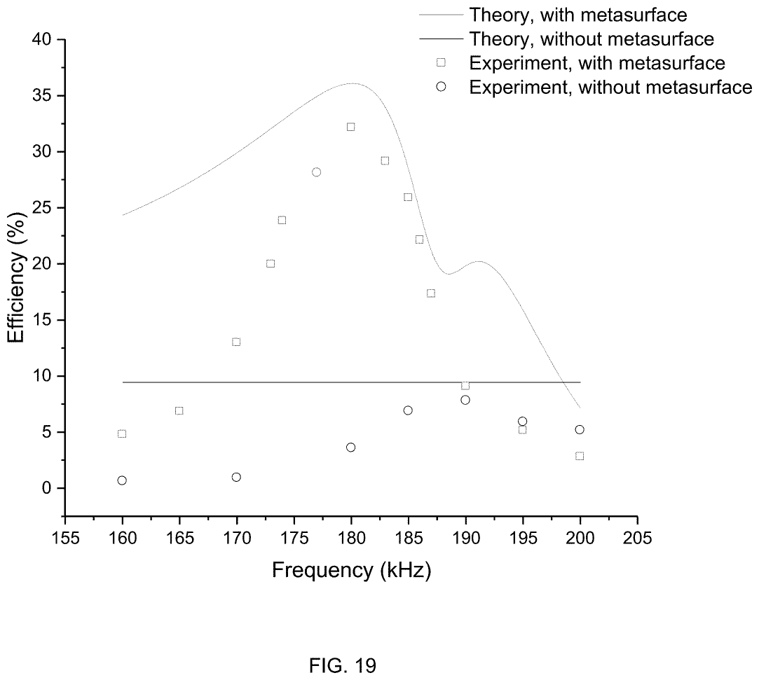

We were able to measure the WPT transmission efficiency with and without metasurface. The receiver is placed at the center, 3 cm away from the metasurface and the targeting current distribution is chosen to be a centered Gaussian beam with FWHM of 1 period. As shown in FIG. 19, the maximum efficiency is 7.82% without the metasurface and 32.17% with the metasurface. The efficiency is improved for over 4 folds with the metasurface.

Multiple Receivers Case.

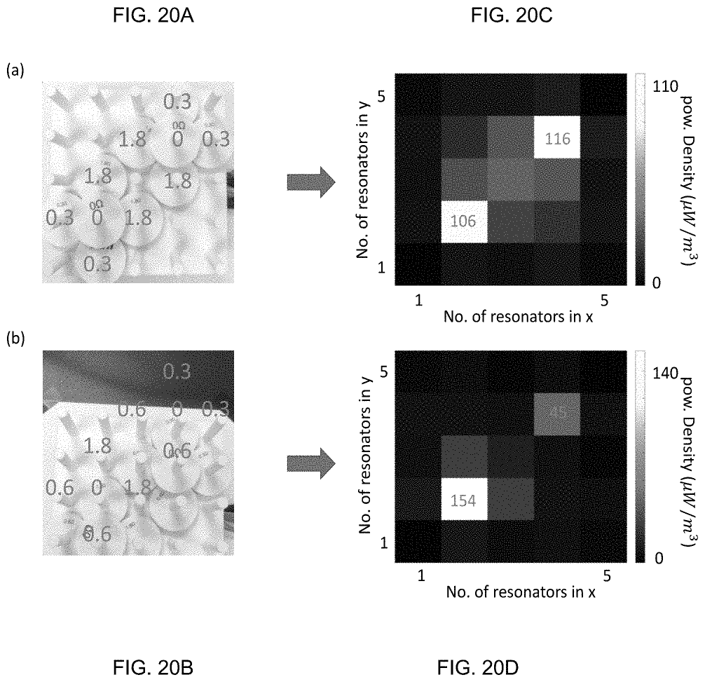

One can change the power density distribution at the position of the two receivers with the impedance distributions shown in FIGS. 20A-20D. The peak targeting currents of the two beams are designed to be 1:1 and 1:0.5 in the two scenarios of FIG. 20A/20C and FIG. 20B/20D, and the magnetic power density should be in the ratio around 1:1 and 1:0.25. The measured magnetic power density is 1:1.09 (106:116) and 1:0.29 (154:45) respectively. The small difference should be because of the fabrication error of the resonators. The measured received power of a 1Ω resistor is 1:0.97 and 1:0.22.

TABLE 4
The receiving voltage for the two scenarios of equal and
non-equal beam intensities shown in FIGs. 20A-20D. The
metasurface is configured to shape two Gaussian beams
with FWHM of 1 period, and center position of [1 period,
1 period] and [−1 period, −1 period] respectively.

| Beam intensity-ratio | Rx1 voltage | Rx2 voltage |
|---|---|---|
| 1:1 | 14.6 mV | 14.4 mV |
| 1:0.5 | 17.4 mV | 8.2 mV |

Consideration of the Skin Effect

As noted, one important application of the invention uses the metasurface as a wearable device, such as within clothing or attached to skin, and the receiver is an implanted device. The skin can be considered in coupling and power transfer for optimizing a design.

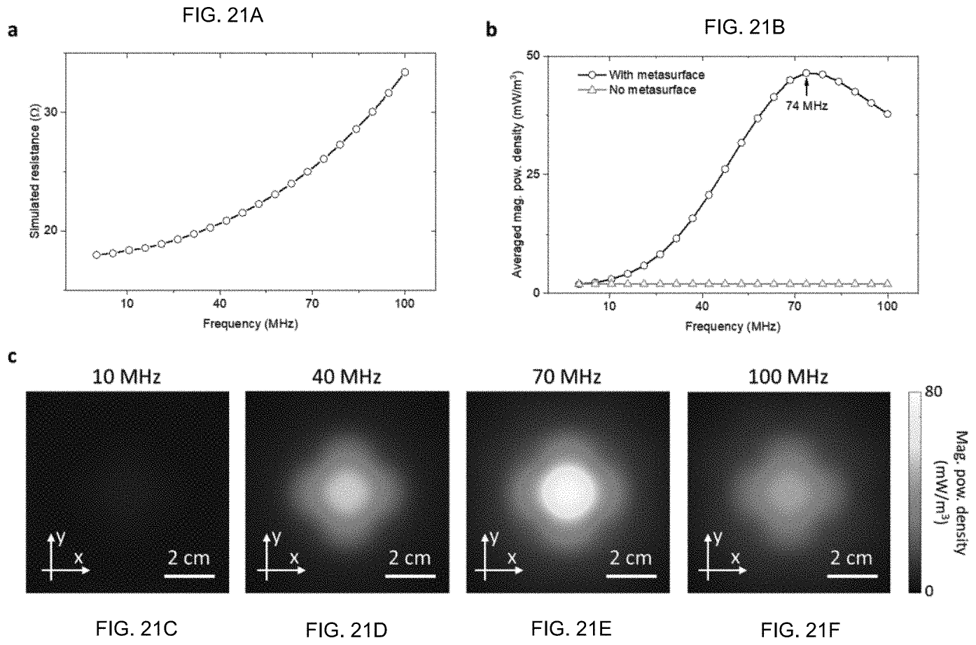

When choosing the operational frequency, it is beneficial to consider two effects: the skin effect and the coupling coefficient of the metasurface to the external magnetic field. The skin effect results in a reduced effective cross-section of the coil where the current flows, and consequently, increased resistance of the unit cells. The resistance increases with the operational frequency due to the reduced skin depth (FIG. 21A). On the other hand, the driving electrical potential from the external magnetic field, as described by the f) term, is proportional to the operational frequency. Due to the two effects, there is an optimal point for the maximized enhancement of the magnetic power density in the region of interest, which is around 74 MHz as shown in FIG. 21B. The field distributions at different frequencies are shown in FIGS. 21C-21F.

Example Preferred Fabrication Process

In FIG. 22A, two layers of the metasurface are first fabricated on two 4″ silicon wafers with photolithography, metal deposition, and lift off. As the cross section shows, the metal contains 3 layers: germanium (Ge) as a sacrificial layer, gold (Au) as a protective layer, and silver (Ag) as a conductive layer. The metals are deposited with electron beam evaporator. FIG. 22B shows that pre-formed PDMS sheets are attached to the wafers. Hydrogen peroxide is used to remove the germanium layer in FIG. 22C. Once the germanium layer is removed, the two layers of the metasurface can be transferred to the PDMS sheet. The top gold layer prevents the oxidation of the silver in air. FIG. 22D shows that chip capacitors with the designed values are connected to the coils with conductive silver paint. FIG. 22D is a picture of the fabricated metasurface resonators on silicon from the step in FIG. 22A.

In an experimental fabrication according to FIGS. 22A-22D, the unit cells are placed into a 5-by-5 array with a period of 13 mm. The spiral coils are first fabricated on two 4″ silicon wafers with photolithography (with dual layers photoresist of LOR 5A and AZ5214E) and lift-off (FIG. 4a). We sequentially deposit germanium (Ge), gold (Au), silver (Ag), and polydimethylsiloxane (PDMS), where PDMS will serve as the new substrate for flexible devices. Ge is a sacrificial layer which will be removed by hydrogen peroxide solution (H₂O₂, 30% solution in water) in the following process of pattern transfer. Au serves as a protection layer against oxidation of the device in the air. Ag serves as a functional layer that provides low resistance. Please note that the functional layer needs to have lower reducibility than Ge (therefore, aluminum and copper cannot work), else Ge cannot be oxidized and dissolved by the H₂O₂ solution. The thicknesses of the metals are Ge 50 nm, Au 20 nm, and Ag 500 nm. The thickness of PDMS is 1.5 mm to balance the durability and flexibility.

During the pattern transfer process, Ge is removed by the H₂O₂ diffused through the small gaps between the PDMS layer and the silicon substrate. This process can be time-consuming with the increase of device size. To speed up this process, we first spin coat and cure a polymethyl methacrylate (PMMA) layer with a thickness of 200 nm on the silicon wafer after the lift-off. Small molecules such as H₂O₂ and water can travel through the thin PMMA layer. We soak the wafer coated with PMMA in H₂O₂ solution to remove the sacrificial layer. The patterns will “float” but are weakly attached to the silicon wafer by the PMMA layer. After cleaning the sample with deionized water and isopropyl alcohol and dry, we pour and cure a PDMS layer to take off the patterns and the transfer is completed. The pattern transfer process does not require use of any toxic chemicals such as HF or any other acids, and can be done outside of a clean room. The patterning of the metasurface uses photolithography and does not require high precision. These factors help in reducing fabrication costs.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A metasurface for wireless power transfer, the metasurface comprising:
an insulated support structure;
a plurality of magnetically coupled resonators insulated and supported by the insulated support structure, the plurality of coupled resonators being configured and arranged to couple within and shape a magnetic near field distribution from a transmitter into a target distribution toward a target receiver, wherein the plurality of coupled resonators comprises a non-uniform impedance distribution pattern to provide the shape of the target distribution.

2. The metasurface of claim 1, wherein the insulated support structure is flexible.

3. The metasurface of claim 2, wherein the plurality of couple resonators are arranged to reshape the magnetic near field through mutual induction between the resonators.

4. The metasurface of claim 2, wherein the insulated support structure comprises a wearable patch.

5. The metasurface of claim 2, wherein the insulated support structure is sized in the range of 5 cm to 20 cm in diameter.

6. The metasurface of claim 1, wherein the non-uniform impedance distribution pattern is predetermined according to a predetermined position and distance relationship between a receiver and a transmitter.

7. The metasurface of claim 6, wherein the predetermined position and distance relationship is defined from one or more of the following:
a body surface position and the position of an implant;
a device surface position and the position of a receiver for a power source of the device;
the orientation of a receiver for the power source of a device;
multiple devices' positions and the relative positions of the receivers for the devices.

8. The metasurface of claim 1, wherein the resonators comprise a compensation capacitor.

9. The metasurface of claim 8, wherein the non-uniform impedance distribution pattern is adjustable via the compensation capacitors of the resonators.

10. A wireless power transfer system including the metasurface of claim 9, a power transmitter, a power receiver, and a controller sets the compensation capacitors to set the the non-uniform impedance distribution pattern according to information about the position between the power transmitter and the receiver.

11. The wireless power transfer system of claim 10, comprising multiple receivers, wherein the controller adjusts the impedance of individual resonators according to information about the position between a transmitter and the multiple receivers to provide a selectable amount of power to each of the multiple receivers.

12. The metasurface of claim 1, wherein the non-uniform impedance distribution pattern is set according to:
$$Im ( {Z}_{n} ) = {ω}_{0} \hat{L} - \frac{1}{{ω}_{0} {C}_{n}} = \frac{{ω}_{0} {\sum }_{k = 1}^{m} {M}_{k n} {a}_{k}^{′}}{{a}_{n}^{′}} . ,$$
where Zₙ is the impedance of the resonator, ω₀ is the operational frequency, \hat{L} is the self-inductance of the resonator, Cₙ is the compenstation capacitance of the n^{th} resonator, Mₖₙ is the mutual inductance between the k^{th} and n^{th} resonators, aₖ′ is the targeting current of the k^{th} resonator.

13. The metasurface of claim 1, wherein the resonators are three-dimensional resonators having coils arranged in respective x, y and z planes.

14. The metasurface of claim 13, wherein the coils comprise a plurality of coils arranged in a primary plane and at least one coil arranged in the other of the respective x, y, and z planes.

15. The metasurface of claim 1, wherein the resonators comprise concentric coil traces of metal.

16. A method for setting a non-uniform impedance distribution pattern of a metasurface that comprises an insulated support structure and a plurality of magnetically coupled resonators insulated and supported by the insulated support structure, the method comprising setting a position and size of a receiver coil, determining a Gaussian beam fitting the position and size, and setting the impedance distribution according to:
$$Im ( {Z}_{n} ) = {ω}_{0} \hat{L} - \frac{1}{{ω}_{0} {C}_{n}} = \frac{{ω}_{0} {\sum }_{k = 1}^{m} {M}_{k n} {a}_{k}^{′}}{{a}_{n}^{′}} . ,$$
where Zₙ is the impedance of the resonator, ω₀ is the operational frequency, \hat{L} is the self-inductance of the resonator, Cₙ is the compenstation capacitance of the n^{th} resonator, Mₖₙ is the mutual inductance between the k^{th} and n^{th} resonators, aₖ′ is the targeting current of the k^{th} resonator.

17. A method for fabricating a metasurface that comprises an insulated support structure and a plurality of magnetically coupled resonators insulated and supported by the insulated support structure, the method comprising:
forming resonator pattern metal traces on a substrate with a sacrificial layer and protective layer under the traces;
attaching a layer of flexible insulator to the metal traces; and
removing the sacrificial layer to release the metal traces attached to the layer of flexible material with the protective layer preventing oxidation.

18. The method according to claim 17, wherein the removing comprises soaking the substrate in solution to float the patterns with weak attachment to the substrate and subsequently conducting the attaching via pouring and curing the flexible insulator onto the patterns with weak attachment to the substrate to complete transfer to the flexible insulator.
